(19) United States
(12) Patent Application Publication
(10) Pub. No.: US 2024/0051676 A1
(43) Pub. Date: Feb. 15, 2024

(54) COOLING SYSTEM AND METHODS FOR REGULATING A TEMPERATURE OF AN ELECTRIC AIRCRAFT POWER SUPPLY DURING CHARGING

(71) Applicant: BETA AIR, LLC, South Burlington, VT (US)

(72) Inventor: John Charles Palombini, SOUTH BURLINGTON, VT (US)

(73) Assignee: BETA AIR, LLC, SOUTH BURLINGTON, VT (US)

(21) Appl. No.: 17/884,359

(22) Filed: Aug. 9, 2022

(51) Int. Cl. B64D 33/08; B60L 58/26; H01M 10/613; H01M 10/625; H01M 10/63; H01M 10/6556; H01M 10/6568

(52) U.S. Cl. CPC B64D 33/08; B60L 58/26; H01M 10/613; H01M 10/625; H01M 10/63; H01M 10/6556; H01M 10/6568; B64C 29/0008

(57) ABSTRACT

Aspects relate to a cooling system for a power supply of an electric aircraft. A cooling system may regulate a temperature of one or more components of a power supply, such as an energy source, a charging port, conductors, and the like. A cooling system may include a channel that a coolant may flow therethrough, where the coolant absorbs heat from the power supply to reduce the temperature of the power supply.

### FIELD OF THE INVENTION

The present invention generally relates to the field of electric aircraft. In particular, the present invention is directed to a cooling system and methods for regulating a temperature of an electric aircraft power supply during charging.

### BACKGROUND

Electric aircraft hold great promise in their ability to run using sustainably source energy without increase atmospheric carbon associated with burning of fossil fuels. Perennial downsides associated with electric aircraft include poor energy storage and recharging capabilities.

### SUMMARY OF THE DISCLOSURE

In an aspect, a cooling system for regulating a temperature of an electric aircraft power supply system during charging is provided. In one or more embodiments, the system includes a cooling system for a power source assembly of an electric aircraft, the system including: a channel extending throughout a power supply of an electric aircraft, the channel configured to contain a coolant that absorbs heat from the power supply during charging of an energy source of the power supply; and a heat exchanger configured to dissipate the heat absorbed by the coolant; and a coolant source configured to circulate the coolant through the channel.

In another aspect, a method for regulating a temperature of an electric aircraft power supply system is provided. In one or more embodiments, the method includes a method for cooling a power source assembly of an electric aircraft during charging, the method including: a channel extending throughout a power assembly of an electric aircraft, the channel configured to contain a coolant that absorbs heat from the power source assembly during charging of a power source of the power source assembly; and a heat exchanger configured to dissipate the heat absorbed by the coolant; and a coolant source configured to circulate the coolant through the channel.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram illustrating an exemplary cooling system in accordance with one or more embodiments of the present disclosure;

FIG. 2 is a block diagram illustrating an exemplary sensor suite in accordance with one or more embodiments of the present disclosure;

FIG. 3 schematically illustrates an exemplary battery module in accordance with one or more embodiments of the present disclosure;

FIG. 4 is a schematic of an exemplary aircraft battery pack having a cooling circuit;

FIG. 5 schematically illustrates an exemplary cooling circuit in accordance with one or more embodiments of the present disclosure;

FIG. 6 is perspective drawings illustrating a battery pack in accordance with one or more embodiments of the present disclosure;

FIG. 7 is a graph that depicts exemplary battery temperature during recharge under a number of exemplary conditions in accordance with one or more embodiments of the present disclosure;

FIG. 8 is a schematic of an exemplary electric aircraft in accordance with one or more embodiments of the present disclosure;

FIG. 9 is a block diagram depicting an exemplary flight controller in accordance with one or more embodiments of the present disclosure;

FIG. 10 is a block diagram of an exemplary machine-learning process in accordance with one or more embodiments of the present disclosure;

FIG. 11 is a flow diagram illustrating an exemplary method of regulating a temperature of a power supply of an electric aircraft using a cooling system in accordance with one or more embodiments of the present disclosure; and

FIG. 12 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to a cooling system and methods for regulating a temperature of an electric aircraft power supply during charging, thus facilitating safe and efficient fast recharging of an electric aircraft. In an embodiment, aspects relate specifically to a cooling system integrated into an electric aircraft that provides cooling to a power supply, such as a power source of an electric aircraft and corresponding electrical systems. For example, cooling system may include a coolant interface that delivers coolant to at least a battery of an electric aircraft during recharging of the battery. Moreover, cooling system may cool, or lower the temperature of, components of a power supply, such as contacts, cables, and/or ports of the power supply to prevent overheating of those elements during recharging as well. As it is generation of heat which prevents fast-charging of electric batteries, aspects of cooling system described herein provides an improvement of existing charging methods.

Aspects of the present disclosure can be used to connect with communication, control, and/or sensor signals associated with an electric aircraft during charging, thereby allowing for monitoring of the charge and feedback control of various charging systems, such as, for example, power sources and coolant sources.

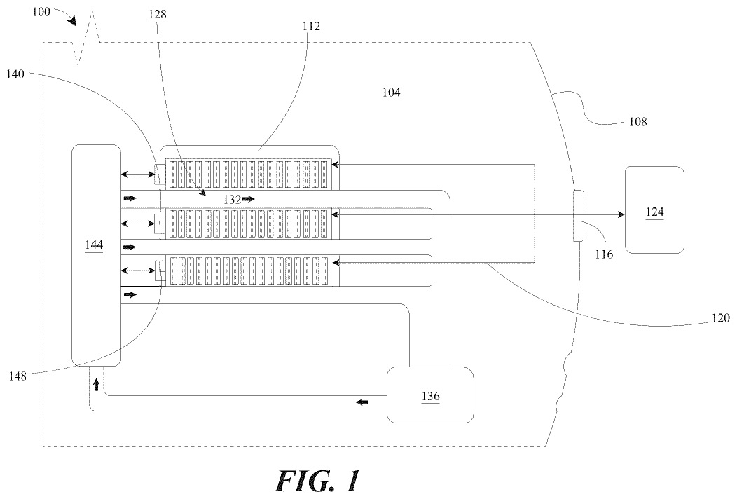

Referring now to FIG. 1, an exemplary cooling system 100 for regulating a temperature of an electric aircraft power supply 104 is illustrated. System 100 may be integrated into electric aircraft 108. System 100 may be used to recharge and/or charge an electrical aircraft. As used in this disclosure, “charging” refers to a process of increasing energy stored within and energy source. In some cases, an energy source includes at least a battery and charging includes providing an electrical current to the at least a battery. As discussed further in this disclosure, a power supply may include an energy source 112, a charging port 116, and/or any other components necessary for transmitted power from charging port 116 to energy source 112. An energy source may be mounted to electric aircraft 108 and configured to provide an electrical charging current. As used in this disclosure, an “energy source” is a source of electrical power, such as, for example, for powering an electric aircraft. In some cases, energy source 112 may include a battery pack, as discussed further below. Energy source 112 may receive power from a charging battery of a charging station during charging of energy source 112 via an electrical charging current. As used in this disclosure, an “electrical charging current” is a flow of electrical charge that facilitates an increase in stored electrical energy of an energy storage, such as, and without limitation, a battery. Energy source 112 may include a plurality of batteries and/or battery packs, battery modules, and/or battery cells. Energy source 112 may house a variety of electrical components. In one embodiment, energy source 112 ay include various cables, wires, circuits, and the like, for facilitating the transfer of power. In one or more embodiments, energy source 112 may include an electric communication with a port 116 of electric aircraft 108, as discussed further below in this disclosure. Energy source 112 and port 116 may be connected via an electrical conductor, such as a wire or cable. Exemplary conductor materials include metals, such as copper, nickel, steel, and the like. As used in this disclosure, “communication” is an attribute wherein two or more relata interact with one another, for example within a specific domain or in a certain manner. In some embodiments, communication between two or more relata may be of a specific domain, such as without limitation electric communication, fluidic communication, informatic communication, mechanic communication, and the like. As used in this disclosure, “electric communication” is an attribute wherein two or more relata interact with one another by way of an electric current or electricity in general. As used in this disclosure, “fluidic communication” is an attribute wherein two or more relata interact with one another by way of a fluidic flow or fluid in general. As used in this disclosure, “informatic communication” is an attribute wherein two or more relata interact with one another by way of an information flow or information in general. As used in this disclosure, “mechanic communication” is an attribute wherein two or more relata interact with one another by way of mechanical means, for instance mechanic effort (e.g., force) and flow (e.g., velocity).

With continued reference to FIG. 1, power supply 104 may include a charging port 116 (also referred to in this disclosure as a “port”) of electric aircraft 108. A connector of a charging station, such as charger 124 or power grid, may connect to charging port 116 to provide power from charger 124 through port 116 and to energy source 112. As used in this disclosure, a “connector” is a distal end of a tether or a bundle of tethers, e.g., hose, tubing, cables, wires, and the like, which is configured to removably attach with a mating component of a port of an electric aircraft. As used in this disclosure, a “port” is an interface configured to interact with another component and/or interface of a charger to allow a transmission of power between an energy source and the charger. For example, and without limitation, port 116 may interface with a number of conductors and/or a coolant flow path by way of receiving a connector. In other embodiments, port 116 may provide an interface between a signal and a computing device. A connector may include a male component having a penetrative form and port 116 may include a female component having a receptive form that is receptive to the male component. Alternatively or additionally, connector may have a female component and port 116 may have a male component. In some cases, connector may include multiple connections, which may make contact and/or communicate with associated mating components within port 116, when the connector is mated with port 116. As used in this disclosure, “mate” is an action of attaching two or more components together. Mating may be performed using an mechanical or electromechanical means. For example, without limitation mating may include an electromechanical device used to join electrical conductors and create an electrical circuit. In some cases, mating may be performed by way of gendered mating components. A gendered mate may include a male component or plug which is inserted within a female component or socket. In some cases, mating may be removable, but require a specialized tool or key for removal. Mating may be achieved by way of one or more of plug and socket mates, pogo pin contact, crown spring mates, and the like. In some cases, mating may be keyed to ensure proper alignment of a connector. In some cases, mate may be lockable. As used in this disclosure, an “electric aircraft” is any electrically power means of human transport, for example without limitation an electric aircraft or electric vertical take-off and landing aircraft. In some cases, an electric aircraft will include an energy source configured to power at least a motor configured to move the electric aircraft 116.

In one or more embodiments, system 100 includes a channel 128 extending throughout a power supply 104 of electric aircraft 108. Channel 128 is configured to contain a coolant that absorbs heat from the power source assembly during charging of a power source of the power source assembly. In one or more embodiments, channel 128 extends from energy source 112 to electric port 116 of the power supply As used in this disclosure, a “channel” is a component that is substantially impermeable to a coolant and contains and/or directs a coolant flow, such as along a coolant flow path. In one or more embodiments, a coolant may include various types of liquids, such as glycol or water. Coolant may traverse along a flow path 132 within channel 128. For example, and without limitation, coolant may flow parallel to a longitudinal axis of channel 128. In one or more embodiments, channel may include a duct, passage, tube, pipe, conduit, and the like. In one or more embodiments, channel 128 may be various shapes and sizes, for example, channel 128 may have a circular, triangular, rectangular, or any other shaped cross-section. Channel 128 may be composed of a rigid material or a flexible material. For example and without limitation, channel 128 may be composed of polypropylene, polycarbonate, acrylonitrile butadiene styrene, polyethylene, nylon, polystyrene, polyether ether ketone, and the like. In one or more embodiments, channel 128 may be arranged in a loop. For example, and without limitation, liquid traversing through channel 128 may repeatedly circulate through channel 128 and be reused as well as liquid may be traversed through channel 128 to a distal end of power supply then return to energy source 112 at the proximal end of power supply. For example, and without limitation, a coolant may be circulated unidirectionally through channel 128. In other embodiments, channel 128 may be a singular path. For example, ad without limitation, channel 128 may include a path that allows for a liquid to move bidirectionally through channel 128. In one or more embodiments, channel 128 may include a plurality of channels (as shown In FIG. 1). For example, and without limitation, one channel may bifurcate into two channels that are configured to be positioned at different locations along energy source 112 and/or components thereof. In another example, channel 128 may be a singular channel that, for example, forms a loop.

In one or more embodiments, channel 128 may include a passage that contains a coolant and allows the coolant to traverse therethrough. As used in this disclosure, “coolant” is any flowable heat transfer medium. Coolant may include a liquid. For example, and without limitation, coolant may be glycol or water, as previously mentioned. Coolant may include a compressible fluid and/or a non-compressible fluid. Coolant may include a non-electrically conductive liquid such as a fluorocarbon-based fluid, such as without limitation Fluorinert™ from 3M of Saint Paul, Minnesota, USA. As used in this disclosure, a “flow of coolant” is a fluid motion of a coolant, such as a stream of coolant. In one or more embodiments, channel 128 may be in fluidic communication with a coolant source 144 and/or a heat exchanger 136, as discussed further below.

In one or more embodiments, channel 128 may abut power supply 104 so that coolant within channel 128 may absorb heat from power supply 104. For example, and without limitation, channel 128 may abut energy source 112 of power supply 104, which may be, for example, a battery and/or battery pack. For instance, and without limitation, channel 128 may abut and run along a conductor of power supply 104 so as to regulate the temperature of various wires and cables of the electric communication between energy source 112 and port 116. In another instance, and without limitation, channel 128 may abut one or more components of port 116 to reduce a temperature of port 116 while conducting a current therethrough to transfer power to energy source 112 from a connected connector and/or charging station. In other embodiments, channel 128 may be partially open so that coolant may contact a component of power supply 104 and absorbed heat.

Still referring to FIG. 1, system 100 includes a heat exchanger 136 configured to dissipate heat absorbed by a coolant. For the purposes of this disclosure, a “heat exchanger” is a component and/or system used to transfer thermal energy, such as heat, from one medium to another. For example, and without limitation, a heat exchanger may be a radiator. In one or more embodiments, heat exchanger 136 may be configured to transfer heat between a coolant and ambient air. As used in this disclosure, “ambient air” is air which is proximal a system and/or subsystem, for instance the air in an environment which a system and/or sub-system is operating. In one or more embodiments, heat exchanger 136 may include a cross-flow, parallel-flow, or counter-flow heat exchanger. In one or more embodiments, heat exchanger 136 may include a finned tube heat exchanger, a plate fin heat exchanger, a plate heat exchanger, a helical-coil heat exchanger, and the like. In other embodiments, heat exchanger 136 includes chillers, Peltier junctions, heat pumps, refrigeration, air conditioning, expansion or throttle valves, and the like, vapor-compression cycle system, vapor absorption cycle system, gas cycle system, Stirling engine, reverse Carnot cycle system, and the like.

In some embodiments, controller 140 may be further configured to control a temperature of coolant. For instance, in some cases, a sensor may be located within thermal communication with coolant, such that sensor is able to detect, measure, or otherwise quantify a temperature of coolant. In some cases, sensor may include a thermometer. Exemplary thermometers include without limitation, pyrometers, infrared non-contacting thermometers, thermistors, thermocouples, and the like. In some cases, thermometer may transduce coolant temperature to a coolant temperature signal and transmit the coolant temperature signal to a controller 140, as discussed further below in this disclosure. Controller 140 may receive coolant temperature signal and control heat transfer between ambient air and coolant as a function of the coolant temperature signal. Controller 140 may use any control method and/or algorithm used in this disclosure to control heat transfer, including without limitation proportional control, proportional-integral control, proportional-integral-derivative control, and the like. In some cases, controller 140 may be further configured to control temperature of coolant within a temperature range below an ambient air temperature. As used in this disclosure, an “ambient air temperature” is temperature of an ambient air. An exemplary non-limiting temperature range below ambient air temperature is about −5° C. to about −30° C. In some cases, coolant flow may have a rate within a specified range. A non-limiting exemplary coolant flow range may be about 0.1 CFM to about 100 CFM. In some cases, rate of coolant flow may be considered as a volumetric flow rate. Alternatively or additionally, rate of coolant flow may be considered as a velocity or flux. In one or more embodiments, heat exchanger 136 may cool, or lower the temperature, of coolant. For example, heat exchanger 136 may cool coolant to below an ambient air temperature. In some cases, coolant source 144 and heat exchanger 136 may be powered by electricity, such as by way of one or more electric motors. Alternatively or additionally, coolant source 144 and heat exchanger 136 may be powered by a combustion engine, for example a gasoline powered internal combustion engine. In one or more embodiments, coolant flow may be configured, such that heat transfer is facilitated between coolant and a battery, by any methods known and/or described in this disclosure. In some cases, coolant flow may be configured to facilitate heat transfer between the coolant flow and at least a conductor of electric aircraft, including, and without limitation, electrical busses connected to energy source 112.

In one or more embodiments, system 100 includes a coolant source that may be actuated to circulate coolant through channel 128, such as along flow path 132. As used in this disclosure, a “coolant source” is an origin, generator, reservoir, or flow of coolant producer. In one or more embodiments, coolant source 144 may include a flow producer, such as a pump or valve, that is configured to displace a coolant within channel 128. In one or more embodiments, coolant source 144 may also include a reservoir, such as a tank or container, that may be configured to store a coolant until the coolant is moved into channel 128 or receive coolant, such as receive coolant returning from absorbing heat from power supply 120-power supply 104. or receives returning liquid. may include a flow producer, such as a fan and/or a pump. Coolant source 144 may include any of following non-limiting examples, air conditioner, refrigerator, heat exchanger, pump, fan, expansion valve, and the like. In one or more embodiments, coolant source 144 is configured to displace coolant through channel 128 during charging of energy source 112 of electric aircraft 108. In some embodiments, channel 128 may facilitate fluidic and/or thermal communication with heat exchanger 136 and, for example, energy source 112 when charger 124 is connected to port 116. In some embodiments, channel 128 may facilitate fluidic and/or thermal communication with coolant source 144 and, for example, energy source 112 when charger 124 is connected to port 116. In some cases, a plurality of channels, coolant sources, and/or connectors may be used to connect to multiple components of electric aircraft 108. In one or more embodiments, cooling of power supply 104 p may be feedback controlled, by way of at least a sensor, and occur until or for a predetermined time after a certain condition has been met, such as, and without limitation, when at least energy source 112 is within a desired temperature range. In some non-limiting cases, controller 140 may use a machine-learning process to optimize cooling time relative of current charging metrics, for example energy source parameters and/or sensor signals. Coolant source 144 may include any computing device described in this disclosure. Coolant source 144 and controller 140 may utilize any machine-learning process described in this disclosure.

Still referring to FIG. 1, in some embodiments, system 100 may additionally include a coolant flow path 128 being located proximal or otherwise in thermal communication with one or more conductors of power supply 104, for example direct current conductor and/or alternating current conductor. In some cases, heat generated within one or more conductors 120 may be transferred into coolant within coolant flow path 128. In some cases, coolant flow path 128 may be arranged substantially coaxial with one or more conductors 120, such that coolant flows substantially parallel with an axis of the one or more conductors 120. Alternatively or additionally, in some cases, coolant flow path 128 may be arranged in cross flow with one or more conductors 120. In some cases, system 100 may include a heat exchanged configured to extract heat from one or more conductors 120, for example at a location of high current and/or high impedance (e.g., resistance) within conductor. In some cases, generated heat within a conductor 120 may be proportional to current within conductor squared. Heating within a conductor 120 may be understood according to Joule heating, also referred to in this disclosure as resistive, resistance, or Ohmic heating. Joule-Lenz law states that power of heat generated by a conductor 120 is proportional to a product of conductor 120 resistance and a square of current within the conductor 120, see below.

P∝I²R

where P is power of heat generated, for example in Watts, I is electric current within conductor 120, for example in Amps, and R is resistance of conductor 120, for example in Ohms. In some cases, coolant flow may be configured to provide a cooling load that is sufficient to cool at least a conductor 120 and one or more electric aircraft batteries during charging.

Still referring to FIG. 1, in some embodiments, one or more of at least a direct current conductor 120 and at least an alternating current conductor 120 may be further configured to conduct a communication signal and/or control signal by way of power line communication. In some cases, controller 104 may be configured within communication of communication signal, for example by way of a power line communication modem. As used in this disclosure, “power line communication” is process of communicating at least a communication signal simultaneously with electrical power transmission. In some cases, power line communication may operate by adding a modulated carrier signal (e.g., communication signal) to a power conductor 120. Different types of power-line communications use different frequency bands. In some case, alternating current may have a frequency of about 50 or about 60 Hz. In some cases, power conductor 120 may be shielded in order to prevent emissions of power line communication modulation frequencies. Alternatively or additionally, power line communication modulation frequency may be within a range unregulated by radio regulators, for example below about 500 KHz.

Still referring to FIG. 1, system 100 may include a controller 140. In one or more embodiments, controller 140 may be communicatively connected to coolant source 144 and power supply 104 and configured to actuate coolant source 144 based on information received regarding power supply 104. Controller 140 may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Controller 140 may include a single computing device operating independently, or may include two or more computing device operating in concert, in parallel, sequentially or the like; two or more computing devices may be included together in a single computing device or in two or more computing devices. Controller 140 may interface or communicate with one or more additional devices as described below in further detail via a network interface device. Network interface device may be utilized for connecting controller 140 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Controller 104 may include but is not limited to, for example, a computing device or cluster of computing devices in a first location and a second computing device or cluster of computing devices in a second location. Controller 140 may include one or more computing devices dedicated to data storage, security, distribution of traffic for load balancing, and the like. Controller 140 may distribute one or more computing tasks as described below across a plurality of computing devices of computing device, which may operate in parallel, in series, redundantly, or in any other manner used for distribution of tasks or memory between computing devices. Controller 140 may be implemented using a “shared nothing” architecture in which data is cached at the worker, in an embodiment, this may enable scalability of system 100 and/or computing device.

In one or more embodiments, controller 140 may be designed and/or configured to perform any method, method step, or sequence of method steps in any embodiment described in this disclosure, in any order and with any degree of repetition. For instance, controller 140 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. controller 140 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

In one or more embodiments, cooling of power supply 104 may be feedback controlled, by way of at least a sensor, and occur until or for a predetermined time after a certain condition has been met, such as, and without limitation, when at least energy source 112 is within a desired temperature range. In some non-limiting cases, controller 140 may use a machine-learning process to optimize cooling time relative of current charging metrics, for example energy source parameters and/or sensor signals. Coolant source 144 may include any computing device described in this disclosure. Coolant source 144 and controller 140 may utilize any machine-learning process described in this disclosure.

In one or more embodiments, controller 140 may generate or receive a control signal. For instance, and without imitation, controller 140 may transmit a control signal to, for example, pump via a communicative connection and/or informatic communication. For example, and without limitation, an informatic communication may include a control signal conductor configured to conduct a control signal. As used in this disclosure, a “control signal conductor” is a conductor configured to carry a control signal between an electric aircraft and a charger. As used in this disclosure, a “control signal” is an electrical signal that is indicative of information. In this disclosure, “control pilot” is used interchangeably in this application with control signal. In some cases, a control signal may include an analog signal or a digital signal. In some cases, control signal may be communicated from one or more sensors, for example located within electric aircraft (e.g., within an electric aircraft battery) and/or located within connector 108. For example, in some cases, control signal may be associated with a battery within an electric aircraft. For example, control signal may include a battery sensor signal. As used in this disclosure, a “battery sensor signal” is a signal representative of a characteristic of a battery. In some cases, battery sensor signal may be representative of a characteristic of an electric aircraft battery, for example as electric aircraft battery is being recharged. In some versions, controller 104 may additionally include a sensor interface configured to receive a battery sensor signal. Sensor interface may include one or more ports, an analog to digital converter, and the like. Controller 104 may be further configured to control one or more of electrical charging current and coolant flow as a function of battery sensor signal and/or control signal. For example, controller 104 may control coolant source 132 and/or power source 124 as a function of battery sensor signal and/or control signal. In some cases, battery sensor signal may be representative of battery temperature. In some cases, battery sensor signal may represent battery cell swell. In some cases, battery sensor signal may be representative of temperature of electric aircraft battery, for example temperature of one or more battery cells within an electric aircraft battery. In some cases, a sensor, a circuit, and/or a controller 104 may perform one or more signal processing steps on a signal. For instance, sensor, circuit or controller 104 may analyze, modify, and/or synthesize a signal in order to improve the signal, for instance by improving transmission, storage efficiency, or signal to noise ratio.

Exemplary methods of signal processing may include analog, continuous time, discrete, digital, nonlinear, and statistical. Analog signal processing may be performed on non-digitized or analog signals. Exemplary analog processes may include passive filters, active filters, additive mixers, integrators, delay lines, compandors, multipliers, voltage-controlled filters, voltage-controlled oscillators, and phase-locked loops. Continuous-time signal processing may be used, in some cases, to process signals which varying continuously within a domain, for instance time. Exemplary non-limiting continuous time processes may include time domain processing, frequency domain processing (Fourier transform), and complex frequency domain processing. Discrete time signal processing may be used when a signal is sampled non-continuously or at discrete time intervals (i.e., quantized in time). Analog discrete-time signal processing may process a signal using the following exemplary circuits sample and hold circuits, analog time-division multiplexers, analog delay lines and analog feedback shift registers. Digital signal processing may be used to process digitized discrete-time sampled signals. Commonly, digital signal processing may be performed by a computing device or other specialized digital circuits, such as without limitation an application specific integrated circuit (ASIC), a field-programmable gate array (FPGA), or a specialized digital signal processor (DSP). Digital signal processing may be used to perform any combination of typical arithmetical operations, including fixed-point and floating-point, real-valued and complex-valued, multiplication and addition. Digital signal processing may additionally operate circular buffers and lookup tables. Further non-limiting examples of algorithms that may be performed according to digital signal processing techniques include fast Fourier transform (FFT), finite impulse response (FIR) filter, infinite impulse response (IIR) filter, and adaptive filters such as the Wiener and Kalman filters. Statistical signal processing may be used to process a signal as a random function (i.e., a stochastic process), utilizing statistical properties. For instance, in some embodiments, a signal may be modeled with a probability distribution indicating noise, which then may be used to reduce noise in a processed signal.

As used in this disclosure, a “controller” is a logic circuit, such as an application-specific integrated circuit (ASIC), FPGA, microcontroller, and/or computing device that is configured to control a subsystem. For example, controller 140 may be configured to control one or more of coolant source 144 and/or energy source 112. In some embodiments controller may control coolant source 144 and/or energy source 112 according to a control signal. As used in this disclosure, “control signal” is any transmission from controller to a subsystem that may affect performance of subsystem. In some embodiments, control signal may be analog. In some cases, control signal may be digital. Control signal may be communicated according to one or more communication protocols, for example without limitation Ethernet, universal asynchronous receiver-transmitter, and the like. In some cases, control signal may be a serial signal. In some cases, control signal may be a parallel signal. Control signal may be communicated by way of a network, for example a controller area network (CAN). In some cases, control signal may include commands to operate coolant source 144 and/or energy source 112. For example, in some cases, coolant source 144 may include a valve to control coolant flow through channel 128, and controller 140 may be configured to control the valve by way of control signal. In some cases, coolant source 144 may include an actuator, such as a pump. Controller 104 may be configured to control the flow of coolant through channel 128 by way of control signal. In some embodiments, coolant source 144 may be configured to control a temperature of coolant, for example, and without limitation, coolant source 144 may include heat exchanger 136.

In one or more embodiments, controller 140 may be configured to selectively engage and/or actuate coolant source 144, for example turning coolant source ON or OFF, by way of control signal. In one or more embodiments, controller 140 may be configured to control a coolant temperature setpoint or range by way of control signal. A coolant temperature setpoint or range may be inputted manually by a user, determined by controller 140 via machine-learning, or received from a database that includes data regarding acceptable temperatures for various types of power supplies. In some cases, energy source 112 may include electrical components configured to control flow of an electric recharging current or switches, relays, direct current to direct current (DC-DC) converters, and the like. In some case, energy source 112 may include one or more circuits configured to provide a variable current source to provide electric recharging current, for example an active current source. Non-limiting examples of active current sources include active current sources without negative feedback, such as current-stable nonlinear implementation circuits, following voltage implementation circuits, voltage compensation implementation circuits, and current compensation implementation circuits, and current sources with negative feedback, including simple transistor current sources, such as constant currant diodes, Zener diode current source circuits, LED current source circuits, transistor current, and the like, Op-amp current source circuits, voltage regulator circuits, and curpistor tubes, to name a few.

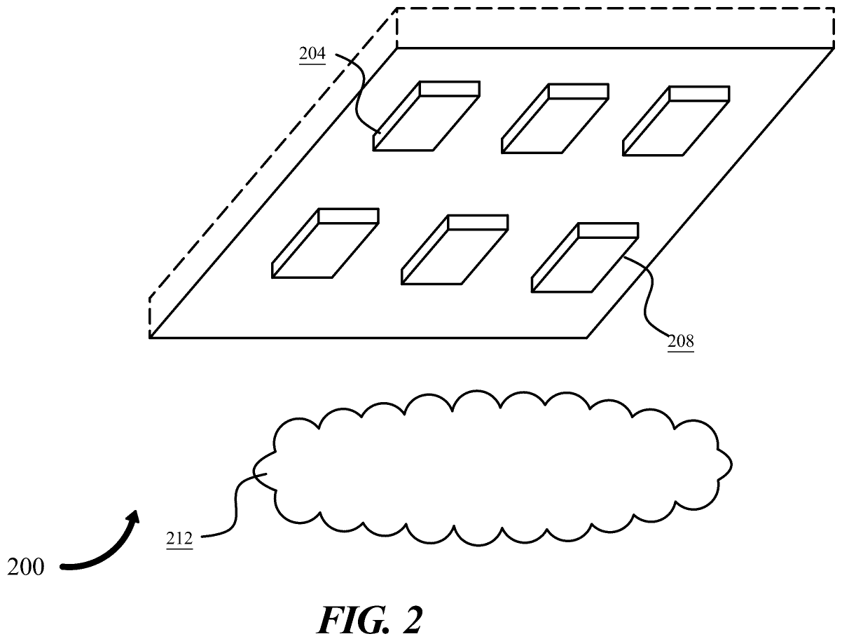

Still referring to FIG. 1, system 100 may include a sensor 148 and/or sensor suite 200 (shown in FIG. 2) connectively connected to controller 140 and power supply 104. In one or more embodiments, sensor 148 may be configured to: detect a characteristic of power supply 104. For instance, and without limitation, sensor 148 may be configured to determine a characteristic such as a charging state of energy source 112 and/or whether or not a connector has mated to port 116. For example, and without limitation, sensor 148 may detect when a connector of a charger has engaged port 116 and is supplying power through port 116 to energy source 112. In another instance, and without limitation, sensor 148 may be configured to detect a characteristic of power supply 104 such as a temperature of energy source 112, port 116, and/or other components of power supply power supply 104. In one or more embodiments, sensor 148 may be further configured to transmit a sensor signal related to the detected characteristic to controller 140 so that controller 140 is configured to actuate coolant source 144 in response to the received sensor signal. In some embodiments, sensor 148 may be located on electric aircraft 108, such as on energy source 112 or energy source 112. In other embodiments, sensor 148 may be remote to electric aircraft 108.

In one or more embodiments, sensor 148 may include a proximity sensor, which may be configured to generate a proximity signal as a function of connection between charger 124 and port 116. As used in this disclosure, a “sensor” is a device that is configured to detect a physical phenomenon or characteristic and transmit information related to the detection. For example, in some cases, a sensor may transduce a detected phenomenon, such as without limitation temperature, pressure, current, voltage, motion, and the like, into a sensed signal (also referred to in this disclosure as a “sensor signal” or a “sensor output signal”). As used in this disclosure, a “proximity sensor” is a sensor that is configured to detect at least a phenomenon related to a component, such as a connector, of a charger being mated to a port of an electric aircraft. Sensor 148 may include any sensor described in this disclosure, including without limitation a switch, a capacitive sensor, a capacitive displacement sensor, a doppler effect sensor, an inductive sensor, a magnetic sensor, an optical sensor (such as without limitation a photoelectric sensor, a photocell, a laser rangefinder, a passive charge-coupled device, a passive thermal infrared sensor, and the like), a radar sensor, a reflection sensor, a sonar sensor, an ultrasonic sensor, fiber optics sensor, a Hall effect sensor, and the like. In one or more embodiments, controller 140 may transmit a control signal, as previously mentioned, based on a received sensor signal. In one or more non-limiting embodiments, a proximity sensor may detect a physical separation between charger 124 and port 116 and, thus, generate a sensor signal that notifies controller 140 that a charging connection between charger 124 and electric aircraft 108 has been created or terminated as a function of the sensor signal.

In one or more embodiments, sensor 148 may detect a characteristic of power supply 104, such as an established charging connection between electric aircraft 108 and charger 124, a temperature of power supply 104 or component thereof, and the like. In one or more embodiments, sensor 148 may be configured to identify a communication of charging connection. For instance, and without limitation, sensor 148 may recognize that a charging connection has been created between charger 124 and electric aircraft 108 that facilitates communication between charger 124 and electric aircraft 108 and thus a transfer of power between charger 124 and energy source 112 of electric aircraft 108. For example, and without limitation, sensor 148 may identify a change in current through port 116, indicating port 116 is in electric communication with, for example, a connector of charger 124. Similarly, sensor 148 may identify that a charging connection has been terminated between electric aircraft 108 and charger 124. For example, and without limitation, sensor 148 may detect that no current is flowing between electric aircraft 108 and charger 124. For the purposes of this disclosure, a “charging connection” is a connection associated with charging a power source, such as, for example, a battery of an electric aircraft. Charging connection may be a wired or wireless connection. Charging connection may include a communication between charger 124 and electric aircraft 108. For example, and without limitation, one or more communications between charger 124 and electric aircraft 108 may be facilitated by charging connection. As used in this disclosure, “communication” is an attribute where two or more relata interact with one another, for example, within a specific domain or in a certain manner. In some cases, communication between two or more relata may be of a specific domain, such as, and without limitation, electric communication, fluidic communication, informatic communication, mechanic communication, and the like. As used in this disclosure, “electric communication” is an attribute wherein two or more relata interact with one another by way of an electric current or electricity in general. For example, and without limitation, a communication between charger 124 and electric aircraft 108 may include an electric communication, where a current flows between charger 124 and electric aircraft 108. As used in this disclosure, “informatic communication” is an attribute wherein two or more relata interact with one another by way of an information flow or information in general. For example, an informatic communication may include a sensor of electric aircraft 108 or a remote device of electric aircraft 108 providing information to controller 104. As used in this disclosure, “mechanic communication” is an attribute wherein two or more relata interact with one another by way of mechanical means, for instance mechanic effort (e.g., force) and flow (e.g., velocity). For example, faster may physically mate with port 116 to create a mechanic communication between electric aircraft 108 and charger 124.

In one or more embodiments, communication of charging connection may include various forms of communication. For example, and without limitation, an electrical contact without making physical contact, for example, by way of inductance, may be made between charger 124 and electric aircraft 108 to facilitate communication. Exemplary conductor materials include metals, such as without limitation copper, nickel, steel, and the like. In one or more embodiments, a contact of charger 124 may be configured to provide electric communication with a mating component within port 116 of electric aircraft 108. In one or more embodiments, contact may be configured to mate with an external connector. In one or more embodiments, connector may be positioned at a distal end of a tether or a bundle of tethers, e.g., hose, tubing, cables, wires, and the like, of charger 124, and connector may be configured to removably attach with a mating component, for example and without limitation, a port of electric aircraft 108. In one or more embodiments, port may include an interface configured to receive another component or an interface configured to transmit and/or receive signal on a computing device. For example, in the case of an electric aircraft port, the port interfaces with a number of conductors and/or a coolant flow paths by way of receiving a connector. In the case of a computing device port, the port may provide an interface between a signal and a computing device. A connector may include a male component having a penetrative form and port may include a female component having a receptive form, receptive to the male component. Alternatively or additionally, connector may have a female component and port may have a male component. In some cases, connector may include multiple connections, which may make contact and/or communicate with associated mating components within port, when the connector is mated with the port.

In one or more embodiments, sensor 148 may include one or more sensors. As used in this disclosure, a “sensor” is a device that is configured to detect an input and/or a phenomenon and transmit information related to the detection. For example, and without limitation, a sensor may transduce a detected charging phenomenon and/or characteristic, such as, and without limitation, temperature, voltage, current, pressure, and the like, into a sensed signal. Sensor 148 may detect a plurality of data about charging connection, electric aircraft 108, and/or charger 124. A plurality of data about, for example, charging connection may include, but is not limited to, battery quality, battery life cycle, remaining battery capacity, current, voltage, pressure, temperature, moisture level, and the like. In one or more embodiments, and without limitation, sensor 148 may include a plurality of sensors. In one or more embodiments, and without limitation, sensor 148 may include one or more temperature sensors, voltmeters, current sensors, hydrometers, infrared sensors, photoelectric sensors, ionization smoke sensors, motion sensors, pressure sensors, radiation sensors, level sensors, imaging devices, moisture sensors, gas and chemical sensors, flame sensors, electrical sensors, imaging sensors, force sensors, Hall sensors, and the like. Sensor 148 may be a contact or a non-contact sensor. For instance, and without limitation, sensor 148 may be connected to electric aircraft 108, charger 124, and/or a controller 140. In other embodiments, sensor 148 may be remote to electric aircraft 108, charger 124, and/or controller 140. As discussed further in this disclosure below, controller 140 may include a computing device, a processor, a pilot control, a controller, control circuit, and the like. In one or more embodiments, sensor 148 may transmit/receive signals to/from controller 140. Signals may include electrical, electromagnetic, visual, audio, radio waves, or another undisclosed signal type alone or in combination.

In one or more embodiments, sensor 148 may include a plurality of independent sensors, where any number of the described sensors may be used to detect any number of physical or electrical quantities associated with communication of charging connection. Independent sensors may include separate sensors measuring physical or electrical quantities that may be powered by and/or in communication with circuits independently, where each may signal sensor output to a control circuit such as a user graphical interface. In an embodiment, use of a plurality of independent sensors may result in redundancy configured to employ more than one sensor that measures the same phenomenon, those sensors being of the same type, a combination of, or another type of sensor not disclosed, so that in the event one sensor fails, the ability of sensor 148 to detect phenomenon may be maintained.

Still referring to FIG. 1, sensor 148 may include a motion sensor. A “motion sensor,” for the purposes of this disclosure, refers to a device or component configured to detect physical movement of an object or grouping of objects. One of ordinary skill in the art would appreciate, after reviewing the entirety of this disclosure, that motion may include a plurality of types including but not limited to: spinning, rotating, oscillating, gyrating, jumping, sliding, reciprocating, or the like. Sensor 148 may include, torque sensor, gyroscope, accelerometer, torque sensor, magnetometer, inertial measurement unit (IMU), pressure sensor, force sensor, proximity sensor, displacement sensor, vibration sensor, among others. In some embodiments, sensor 148 may include a pressure sensor. A “pressure,” for the purposes of this disclosure, and as would be appreciated by someone of ordinary skill in the art, is a measure of force required to stop a fluid from expanding and is usually stated in terms of force per unit area. In non-limiting exemplary embodiments, a pressure sensor may be configured to measure an atmospheric pressure and/or a change of atmospheric pressure. In some embodiments, a pressure sensor may include an absolute pressure sensor, a gauge pressure sensor, a vacuum pressure sensor, a differential pressure sensor, a sealed pressure sensor, and/or other unknown pressure sensors or alone or in a combination thereof. In some embodiments, the pressure sensor may be used to indirectly measure fluid flow, speed, water level, and altitude. In some embodiments, a pressure sensor may be configured to transform a pressure into an analogue electrical signal. In some embodiments, the pressure sensor may be configured to transform a pressure into a digital signal. In one or more embodiments, sensor 148 may detect a characteristic of connector 100 by detecting a pressure created by coolant flowing through channel 128 or a force exerted by coolant source 144 of system 100 to move coolant through channel 128 and along a coolant path.

In one or more embodiments, sensor 148 may include electrical sensors. Electrical sensors may be configured to measure voltage across a component, electrical current through a component, and resistance of a component. In one or more embodiments, sensor 108 may include thermocouples, thermistors, thermometers, infrared sensors, resistance temperature sensors (RTDs), semiconductor based integrated circuits (ICs), a combination thereof, or another undisclosed sensor type, alone or in combination. Temperature, for the purposes of this disclosure, and as would be appreciated by someone of ordinary skill in the art, is a measure of the heat energy of a system. Temperature, as measured by any number or combinations of sensors present within sensor 108, may be measured in Fahrenheit (° F.), Celsius (° C.), Kelvin (° K), or another scale alone or in combination. The temperature measured by sensors may comprise electrical signals, which are transmitted to their appropriate destination wireless or through a wired connection.

Referring now to FIG. 2, an embodiment of sensor suite 200 is presented. The herein disclosed system and method may comprise a plurality of sensors in the form of individual sensors or a sensor suite working in tandem or individually. In some cases, sensor suite 200 may communicate by way of at least a conductor, such as within limitation a control signal conductor. Alternatively and/or additionally, in some cases, sensor suite 200 may be communicative by at least a network, for example any network described in this disclosure including wireless (Wi-Fi), controller area network (CAN), the Internet, and the like. A sensor suite may include a plurality of independent sensors, as described herein, where any number of the described sensors may be used to detect any number of physical or electrical quantities associated with an aircraft battery or an electrical energy storage system, such as without limitation charging battery. Independent sensors may include separate sensors measuring physical or electrical quantities that may be powered by and/or in communication with circuits independently, where each may signal sensor output to a control circuit such as a user graphical interface. In a non-limiting example, there may be four independent sensors housed in and/or on battery pack measuring temperature, electrical characteristic such as voltage, amperage, resistance, or impedance, or any other parameters and/or quantities as described in this disclosure. In an embodiment, use of a plurality of independent sensors may result in redundancy configured to employ more than one sensor that measures the same phenomenon, those sensors being of the same type, a combination of, or another type of sensor not disclosed, so that in the event one sensor fails, the ability of controller 104 and/or user to detect phenomenon is maintained.

With continued reference to FIG. 2, sensor suite 200 may include a humidity sensor 204. Humidity, as used in this disclosure, is the property of a gaseous medium (almost always air) to hold water in the form of vapor. An amount of water vapor contained within a parcel of air can vary significantly. Water vapor is generally invisible to the human eye and may be damaging to electrical components. There are three primary measurements of humidity, absolute, relative, specific humidity. “Absolute humidity,” for the purposes of this disclosure, describes the water content of air and is expressed in either grams per cubic meters or grams per kilogram. “Relative humidity”, for the purposes of this disclosure, is expressed as a percentage, indicating a present stat of absolute humidity relative to a maximum humidity given the same temperature. “Specific humidity”, for the purposes of this disclosure, is the ratio of water vapor mass to total moist air parcel mass, where parcel is a given portion of a gaseous medium. Humidity sensor 204 may be psychrometer. Humidity sensor 204 may be a hygrometer. Humidity sensor 204 may be configured to act as or include a humidistat. A “humidistat”, for the purposes of this disclosure, is a humidity-triggered switch, often used to control another electronic device. Humidity sensor 204 may use capacitance to measure relative humidity and include in itself, or as an external component, include a device to convert relative humidity measurements to absolute humidity measurements. “Capacitance”, for the purposes of this disclosure, is the ability of a system to store an electric charge, in this case the system is a parcel of air which may be near, adjacent to, or above a battery cell.

With continued reference to FIG. 2, sensor suite 200 may include multimeter 208. Multimeter 208 may be configured to measure voltage across a component, electrical current through a component, and resistance of a component. Multimeter 208 may include separate sensors to measure each of the previously disclosed electrical characteristics such as voltmeter, ammeter, and ohmmeter, respectively.

Alternatively or additionally, and with continued reference to FIG. 2, sensor suite 200 may include a sensor or plurality thereof that may detect voltage and direct charging of individual battery cells according to charge level; detection may be performed using any suitable component, set of components, and/or mechanism for direct or indirect measurement and/or detection of voltage levels, including without limitation comparators, analog to digital converters, any form of voltmeter, or the like. Sensor suite 200 and/or a control circuit incorporated therein and/or communicatively connected thereto may be configured to adjust charge to one or more battery cells as a function of a charge level and/or a detected parameter. For instance, and without limitation, sensor suite 200 may be configured to determine that a charge level of a battery cell is high based on a detected voltage level of that battery cell or portion of the battery pack. Sensor suite 200 may alternatively or additionally detect a charge reduction event, defined for purposes of this disclosure as any temporary or permanent state of a battery cell requiring reduction or cessation of charging; a charge reduction event may include a cell being fully charged and/or a cell undergoing a physical and/or electrical process that makes continued charging at a current voltage and/or current level inadvisable due to a risk that the cell will be damaged, will overheat, or the like. Detection of a charge reduction event may include detection of a temperature, of the cell above a threshold level, detection of a voltage and/or resistance level above or below a threshold, or the like. Sensor suite 200 may include digital sensors, analog sensors, or a combination thereof. Sensor suite 200 may include digital-to-analog converters (DAC), analog-to-digital converters (ADC, A/D, A-to-D), a combination thereof, or other signal conditioning components used in transmission of a battery sensor signal to a destination over wireless or wired connection.

With continued reference to FIG. 2, sensor suite 200 may include thermocouples, thermistors, thermometers, passive infrared sensors, resistance temperature sensors (RTD's), semiconductor based integrated circuits (IC), a combination thereof or another undisclosed sensor type, alone or in combination. Temperature, for the purposes of this disclosure, and as would be appreciated by someone of ordinary skill in the art, is a measure of the heat energy of a system. Temperature, as measured by any number or combinations of sensors present within sensor suite 200, may be measured in Fahrenheit (° F.), Celsius (° C.), Kelvin (° K), or another scale alone or in combination. The temperature measured by sensors may comprise electrical signals which are transmitted to their appropriate destination wireless or through a wired connection.

With continued reference to FIG. 2, sensor suite 200 may include a sensor configured to detect gas that may be emitted during or after a catastrophic cell failure. “Catastrophic cell failure”, for the purposes of this disclosure, refers to a malfunction of a battery cell, which may be an electrochemical cell, that renders the cell inoperable for its designed function, namely providing electrical energy to at least a portion of an electric aircraft. Byproducts of catastrophic cell failure 212 may include gaseous discharge including oxygen, hydrogen, carbon dioxide, methane, carbon monoxide, a combination thereof, or another undisclosed gas, alone or in combination. Further the sensor configured to detect vent gas from electrochemical cells may comprise a gas detector. For the purposes of this disclosure, a “gas detector” is a device used to detect a gas is present in an area. Gas detectors, and more specifically, the gas sensor that may be used in sensor suite 200, may be configured to detect combustible, flammable, toxic, oxygen depleted, a combination thereof, or another type of gas alone or in combination. The gas sensor that may be present in sensor suite 200 may include a combustible gas, photoionization detectors, electrochemical gas sensors, ultrasonic sensors, metal-oxide-semiconductor (MOS) sensors, infrared imaging sensors, a combination thereof, or another undisclosed type of gas sensor alone or in combination. Sensor suite 200 may include sensors that are configured to detect non-gaseous byproducts of catastrophic cell failure 212 including, in non-limiting examples, liquid chemical leaks including aqueous alkaline solution, ionomer, molten phosphoric acid, liquid electrolytes with redox shuttle and ionomer, and salt water, among others. Sensor suite 200 may include sensors that are configured to detect non-gaseous byproducts of catastrophic cell failure 212 including, in non-limiting examples, electrical anomalies as detected by any of the previous disclosed sensors or components.

With continued reference to FIG. 2, sensor suite 200 may be configured to detect events where voltage nears an upper voltage threshold or lower voltage threshold. The upper voltage threshold may be stored in data storage system for comparison with an instant measurement taken by any combination of sensors present within sensor suite 200. The upper voltage threshold may be calculated and calibrated based on factors relating to battery cell health, maintenance history, location within battery pack, designed application, and type, among others. Sensor suite 200 may measure voltage at an instant, over a period of time, or periodically. Sensor suite 200 may be configured to operate at any of these detection modes, switch between modes, or simultaneous measure in more than one mode. Controller 104 may detect through sensor suite 200 events where voltage nears the lower voltage threshold. The lower voltage threshold may indicate power loss to or from an individual battery cell or portion of the battery pack. Controller 104 may detect through sensor suite 200 events where voltage exceeds the upper and lower voltage threshold. Events where voltage exceeds the upper and lower voltage threshold may indicate battery cell failure or electrical anomalies that could lead to potentially dangerous situations for aircraft and personnel that may be present in or near its operation.

With continued reference to FIG. 2, in some cases, sensor suite 200 may include a swell sensor configured to sense swell, pressure, or strain of at least a battery cell. In some cases, battery cell swell, pressure, and/or strain may be indicative of an amount of gases and/or gas expansion within a battery cell. Battery swell sensor may include one or more of a pressure sensor, a load cell, and a strain gauge. In some cases, battery swell sensor may output a battery swell signal that is analog and requires signal processing techniques. For example, in some cases, wherein battery swell sensor includes at least a strain gauge, battery swell signal may be processed and digitized by one or more of a Wheatstone bridge, an amplifier, a filter, and an analog to digital converter. In some cases, battery sensor signal may include battery swell signal.

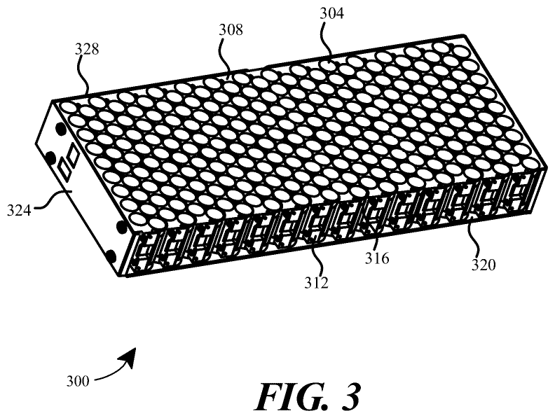

Referring now to FIG. 3, an exemplary component of an electric aircraft energy source is illustrated. An energy source may include a battery that may include a battery or module. For example, and without limitation a battery may include a plurality of battery modules. As shown in FIG. 3, battery module 300 may include multiple battery units 316 is illustrated, according to embodiments. Battery module 300 may comprise a battery cell 304, cell retainer 308, cell guide 312, protective wrapping, back plate 320, end cap 324, and side panel 328. Battery module 300 may comprise a plurality of battery cells, an individual of which is labeled 304. In embodiments, battery cells 304 may be disposed and/or arranged within a respective battery unit 316 in groupings of any number of columns and rows. For example, in the illustrative embodiment of FIG. 3, battery cells 304 are arranged in each respective battery unit 316 with 18 cells in two columns. It should be noted that although the illustration may be interpreted as containing rows and columns, that the groupings of battery cells in a battery unit, that the rows are only present as a consequence of the repetitive nature of the pattern of staggered battery cells and battery cell holes in cell retainer being aligned in a series. While in the illustrative embodiment of FIG. 3 battery cells 304 are arranged 18 to battery unit 316 with a plurality of battery units 316 comprising battery module 300, one of skill in the art will understand that battery cells 304 may be arranged in any number to a row and in any number of columns and further, any number of battery units may be present in battery module 300. According to embodiments, battery cells 304 within a first column may be disposed and/or arranged such that they are staggered relative to battery cells 304 within a second column. In this way, any two adjacent rows of battery cells 304 may not be laterally adjacent but instead may be respectively offset a predetermined distance. In embodiments, any two adjacent rows of battery cells 304 may be offset by a distance equal to a radius of a battery cell. This arrangement of battery cells 304 is only a non-limiting example and in no way preclude other arrangement of battery cells.

In embodiments, battery cells 304 may be fixed in position by cell retainer 308. For the illustrative purposed within FIG. 3, cell retainer 308 is depicted as the negative space between the circles representing battery cells 304. Cell retainer 308 comprises a sheet further comprising circular openings that correspond to the cross-sectional area of an individual battery cell 304. Cell retainer 308 comprises an arrangement of openings that inform the arrangement of battery cells 304. In embodiments, cell retainer 308 may be configured to non-permanently, mechanically couple to a first end of battery cell 304.

According to embodiments, battery module 300 may further comprise a plurality of cell guides 312 corresponding to each battery unit 316. Cell guide 312 may comprise a solid extrusion with cutouts (e.g. scalloped) corresponding to the radius of the cylindrical battery cell 304. Cell guide 312 may be positioned between the two columns of a battery unit 316 such that it forms a surface (e.g. side surface) of the battery unit 316. In embodiments, the number of cell guides 312 therefore match in quantity to the number of battery units 316. Cell guide 312 may comprise a material suitable for conducting heat.

Battery module 300 may also comprise a protective wrapping woven between the plurality of battery cells 304. Protective wrapping may provide fire protection, thermal containment, and thermal runaway during a battery cell malfunction or within normal operating limits of one or more battery cells 304 and/or potentially, battery module 300 as a whole. Battery module 300 may also comprise a backplate 320. Backplate 320 is configured to provide structure and encapsulate at least a portion of battery cells 304, cell retainers 308, cell guides 312, and protective wraps. End cap 324 may be configured to encapsulate at least a portion of battery cells 304, cell retainers 308, cell guides 312, and battery units 316, as will be discussed further below, end cap may comprise a protruding boss that clicks into receivers in both ends of back plate 320, as well as a similar boss on a second end that clicks into sense board. Side panel 328 may provide another structural element with two opposite and opposing faces and further configured to encapsulate at least a portion of battery cells 304, cell retainers 308, cell guides 312, and battery units 316.

Still referring to FIG. 3, in embodiments, battery module 300 can include one or more battery cells 304. In another embodiment, battery module 300 comprises a plurality of individual battery cells 304. Battery cells 304 may each comprise a cell configured to include an electrochemical reaction that produces electrical energy sufficient to power at least a portion of an electric aircraft and/or a cart 100. Battery cell 304 may include electrochemical cells, galvanic cells, electrolytic cells, fuel cells, flow cells, voltaic cells, or any combination thereof—to name a few. In embodiments, battery cells 304 may be electrically connected in series, in parallel, or a combination of series and parallel. Series connection, as used herein, comprises wiring a first terminal of a first cell to a second terminal of a second cell and further configured to comprise a single conductive path for electricity to flow while maintaining the same current (measured in Amperes) through any component in the circuit. Battery cells 304 may use the term ‘wired’, but one of ordinary skill in the art would appreciate that this term is synonymous with ‘electrically connected’, and that there are many ways to couple electrical elements like battery cells 304 together. As an example, battery cells 304 can be coupled via prefabricated terminals of a first gender that mate with a second terminal with a second gender. Parallel connection, as used herein, comprises wiring a first and second terminal of a first battery cell to a first and second terminal of a second battery cell and further configured to comprise more than one conductive path for electricity to flow while maintaining the same voltage (measured in Volts) across any component in the circuit. Battery cells 304 may be wired in a series-parallel circuit which combines characteristics of the constituent circuit types to this combination circuit. Battery cells 304 may be electrically connected in any arrangement which may confer onto the system the electrical advantages associated with that arrangement such as high-voltage applications, high-current applications, or the like.

As used herein, an electrochemical cell is a device capable of generating electrical energy from chemical reactions or using electrical energy to cause chemical reactions. Further, voltaic or galvanic cells are electrochemical cells that generate electric current from chemical reactions, while electrolytic cells generate chemical reactions via electrolysis. As used herein, the term ‘battery’ is used as a collection of cells connected in series or parallel to each other.

According to embodiments and as discussed above, any two rows of battery cells 304 and therefore cell retainer 308 openings are shifted one half-length so that no two battery cells 304 are directly next to the next along the length of the battery module 300, this is the staggered arrangement presented in the illustrated embodiment of FIG. 3. Cell retainer 308 may employ this staggered arrangement to allow more cells to be disposed closer together than in square columns and rows like in a grid pattern. The staggered arrangement may also be configured to allow better thermodynamic dissipation, the methods of which may be further disclosed hereinbelow. Cell retainer 308 may comprise staggered openings that align with battery cells 304 and further configured to hold battery cells 304 in fixed positions. Cell retainer 308 may comprise an injection molded component. Injection molded component may comprise a component manufactured by injecting a liquid into a mold and letting it solidify, taking the shape of the mold in its hardened form. Cell retainer 308 may comprise liquid crystal polymer, polypropylene, polycarbonate, acrylonitrile butadiene styrene, polyethylene, nylon, polystyrene, polyether ether ketone, to name a few. Cell retainer 308 may comprise a second cell retainer fixed to the second end of battery cells 304 and configured to hold battery cells 304 in place from both ends. The second cell retainer may comprise similar or the exact same characteristics and functions of first cell retainer 308. Battery module 300 may also comprise cell guide 312. Cell guide 312 includes material disposed in between two rows of battery cells 304. In embodiments, cell guide 312 can be configured to distribute heat that may be generated by battery cells 304.

According to embodiments, battery module 300 may also comprise back plate 320. Back plate 320 is configured to provide a base structure for battery module 300 and may encapsulate at least a portion thereof. Backplate 320 can have any shape and includes opposite, opposing sides with a thickness between them. In embodiments, back plate 320 may comprise an effectively flat, rectangular prism shaped sheet. For example, back plate 320 can comprise one side of a larger rectangular prism which characterizes the shape of battery module 300 as a whole. Back plate 320 also comprises openings correlating to each battery cell 304 of the plurality of battery cells 304. Back plate 320 may comprise a lamination of multiple layers. The layers that are laminated together may comprise FR-4, a glass-reinforced epoxy laminate material, and a thermal barrier of a similar or exact same type as disclosed hereinabove. Back plate 320 may be configured to provide structural support and containment of at least a portion of battery module 300 as well as provide fire and thermal protection.

According to embodiments, battery module 300 may also comprise first end cap 324 configured to encapsulate at least a portion of battery module 300. End cap 324 may provide structural support for battery module 300 and hold back plate 320 in a fixed relative position compared to the overall battery module 300. End cap 324 may comprise a protruding boss on a first end that mates up with and snaps into a receiving feature on a first end of back plate 320. End cap 324 may comprise a second protruding boss on a second end that mates up with and snaps into a receiving feature on sense board.

Battery module 300 may also comprise at least a side panel 328 that may encapsulate two sides of battery module 300. Side panel 328 may comprise opposite and opposing faces comprising a metal or composite material. In the illustrative embodiment of FIG. 3, a second side panel 328 is present but not illustrated so that the inside of battery module 300 may be presented. Side panel(s) 328 may provide structural support for battery module 300 and provide a barrier to separate battery module 300 from exterior components within aircraft or environment.

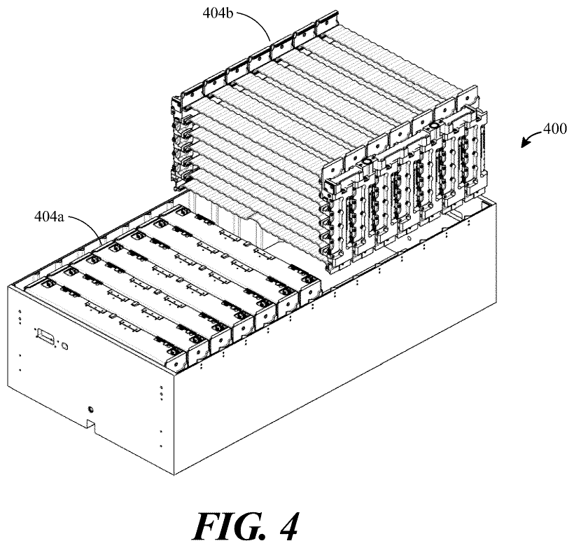

Referring now to FIG. 4, schematically illustrates an exemplary energy source, aircraft battery 400, in an isometric view. As previously mentioned, system 100 may be near or integrated into an energy source of an electric aircraft. For example, and without limitation, electric aircraft battery 400 may include a cooling circuit 404 of system 100. FIG. 4 illustrates aircraft battery 400 with one cooling circuit installed 404a and one cooling circuit uninstalled 404b. In some embodiments, battery 400 may include two or more cooling circuits 404a,b. Cooling circuits may be configured to allow coolant flow through a proximal battery module. In some cases, a thermal gradient between coolant and battery modules cools battery 400.

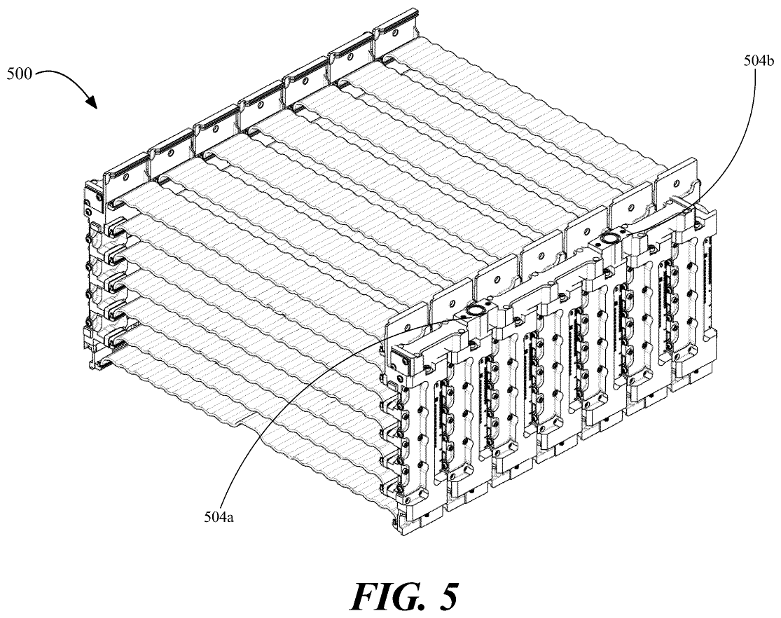

Referring now to FIG. 5, schematically illustrates an exemplary cooling circuit 500, in an isometric view. In some cases, aircraft battery 400 may include a cooling circuit 500. Cooling circuit 500 may be configured to accept coolant flow, for example, from channel 128, and direct coolant proximal battery module and/or battery cells. In some cases, cooling circuit 500 may be configured to direct flow of coolant out of cooling circuit after it has passed through cooling circuit. In some cases, cooling circuit 500 may be configured to return coolant, for example to coolant source 144 by way of channel 128. Alternatively and/or additionally, cooling circuit 500 may direct or vent coolant out of cooling circuit substantially into atmosphere. In some embodiments, cooling circuit 500 may comprise one or more coolant fittings 504a,b. Coolant fittings 504a,b may be configured to accept a flow of coolant from, for example, channel 128 and coolant source 144. Alternatively or additionally, coolant fittings 504a,b may be configured to return a flow of coolant, for example by way of a coolant return, such as channel 128.

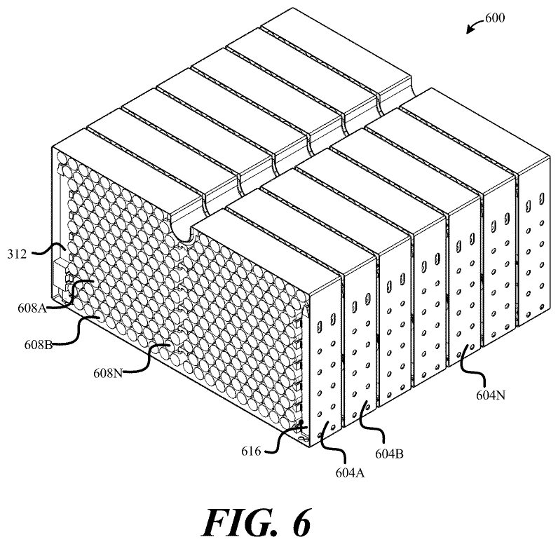

Referring now to FIG. 6, a perspective drawing of an embodiment of a battery pack with a plurality of battery modules disposed therein. The configuration of battery pack 600 is merely exemplary and should in no way be considered limiting. Battery pack 600 is configured to include an integrated channel that facilitates the flow of coolant through each battery module of the plurality of battery modules to cool the battery pack. Battery pack 600 can include one or more battery modules 604A-N. Battery pack 600 is configured to house and/or encase one or more battery modules 604A-N. Each battery module of the plurality of battery modules 604A-N may include any battery module as described in further detail in the entirety of this disclosure. As an exemplary embodiment, FIG. 6 illustrates seven battery modules 604A-N creating battery pack 600, however, a person of ordinary skill in the art would understand that any number of battery modules 604A-N may be housed within battery pack 600. In an embodiment, each battery module of the plurality of battery modules 604A-N can include one or more battery cells 608A-N. Each battery module 604A-N is configured to house and/or encase one or more battery cells 608A-N. Each battery cell of the plurality of battery cells 608A-N may include any battery cell as described in further detail in the entirety of this disclosure. Battery cells 608A-N may be configured to be contained within each battery module 604A-N, wherein each battery cell 608A-N is disposed in any configuration without limitation. As an exemplary embodiment, FIG. 6 illustrates 240 battery cells 608A-N housed within each battery module 604A-N, however, a person of ordinary skill in the art would understand that any number of battery units 608A-N may be housed within each battery module 604A-N of battery pack 600. Further, each battery module of the plurality of battery modules 604A-N of battery pack 600 includes circuit 612. Circuit 612 may include any circuit as described in further detail in the entirety of this disclosure. Each battery module of the plurality of battery modules 604A-N further includes second circuit 616. Second circuit 616 may include any circuit as described in further detail in the entirety of this disclosure. Persons skilled in the art, upon reviewing the entirety of this disclosure, will be aware of various configurations of the plurality of battery modules that may be utilized for the battery pack consistently with this disclosure.

According to some embodiments, a battery unit may be configured to couple to one or more other battery units, wherein the combination of two or more battery units forms at least a portion of aircraft battery and/or charging battery.

In the instant embodiment, for example and without limitation, battery unit includes a first row of battery cells, wherein first row of battery cells is in contact with the first side of channel 128, as described in further detail below. As a non-limiting example, a row of battery cells is configured to contain ten columns of battery cells. Further, in the instant embodiment, for example and without limitation, battery unit includes a second row of battery cells, wherein second row of battery cells is in contact with the second side of channel 128, as described in further detail below. As a non-limiting example, second row of battery cells is configured to contain ten columns of battery cells. In some embodiments, battery unit may be configured to contain twenty battery cells in first row and second row. Battery cells of battery unit may be arranged in any configuration, such that battery unit may contain any number of rows of battery cells and any number of columns of battery cells. In embodiments, battery unit may contain any offset of distance between first row of battery cells and second row of battery cells, wherein the battery cells of first row and the battery cells of second row are not centered with each other. In the instant embodiment, for example and without limitation, battery unit includes first row and adjacent second row each containing ten battery cells, each battery cell of first row and each battery cell of second row are shifted a length measuring the radius of a battery cell, wherein the center of each battery cell of first row and each battery cell of second row are separated from the center of the battery cell in the adjacent column by a length equal to the radius of the battery cell. As a further example and without limitation, each battery cell of first row and each battery cell of second row are shifted a length measuring a quarter the diameter of each battery cell, wherein the center of each battery cell of first row and each battery cell of second row are separated from the center of a battery cell in the adjacent column by a length equal to a quarter of the diameter of the battery cell. First row of battery cells and second row of battery cells of the at least a battery unit may be configured to be fixed in a position by utilizing a cell retainer, as described in the entirety of this disclosure. Each battery cell may be connected utilizing any means of connection as described in the entirety of this disclosure. In some embodiments, battery unit may include channel 128, wherein channel 128 has a first surface and a second opposite and opposing surface. Channel 128 may include any channel 128 as described above in this disclosure. In some cases, height of channel 128 may not exceed the height of battery cells. For example and without limitation, channel 128 may be at a height that is equal to the height of each battery cell of first row and second row. Channel 128 may be composed of any suitable material, as described above in further detail in this disclosure. Channel 128 may be configured to include an indent in the component for each battery cell coupled to the first surface and/or the second surface of channel 128. Persons skilled in the art, upon reviewing the entirety of this disclosure, will be aware of components that may be used as channels and/or thermal conduits consistently with this disclosure.

Continuing with reference to some embodiments, channel 128 may include at least a passage, wherein the passage includes a void, which includes an opening starting at the first end of channel 128 and terminating at a second, opposing end of channel 128. Thus, a portion of channel 128 may run through or within battery 600 and may be a horizontal channel with openings on each end of the channel. An interior surface of channel 128 may define passage. A passage of channel 128 may be configured to have a hollow shape comprising one or more sides, at least two ends, and a length. The hollow shape of channel 128 may include a void having a shape the same as or different from the shape of the at least a passage and terminating at an opposite, opposing second end of the shape (e.g., the cross-section of the channel), as previously mentioned in this disclosure. In one or more embodiments, channel 128 may include portions that runs effectively perpendicular to each battery cell. In embodiments, passage may be disposed within channel 128 such that passage forms a void originating at a first side of the battery module and terminating at the second, opposite, and opposing side, of the battery module. According to embodiments, channel 128 may be composed utilizing any suitable material. For example, and without limitation, channel 128 may be composed of polypropylene, polycarbonate, acrylonitrile butadiene styrene, polyethylene, nylon, polystyrene, polyether ether ketone, and the like.

In some embodiments, channel 128 may be disposed such that a passage is configured to allow the travel of a coolant from a first end of channel 128 to a second, opposite, and opposite end of channel 128. For example, and without limitation, passage can be disposed to allow the movement of a coolant within the channel 128 and along a flow path. A passage of channel 128 may be configured to be of any size and/or diameter. For example, and without limitation, the hollow opening of passage may be configured to have a diameter that is equal to or less than the radius of each battery cell. In one or more embodiments, channel 128 may have a length equal or less than the length of one row of battery cells such that channel 128 is configured to not exceed the length of first row and/or second row of battery cells. The opening of the at least a passage can be configured to be disposed at each end of channel 128, wherein the at least a passage may be in contact with each battery cell in a respective battery unit located at the end of each column and/or row of the battery unit. For example, and without limitation, in some embodiments, a battery unit can contain two rows with ten columns of battery cells and the opening of the at least a passage on each end of channel 128 that is in contact with a respective battery cell at the end of each of the two columns. Persons skilled in the art, upon reviewing the entirety of this disclosure, will be aware of various components that may be used as at least a passage consistently with this disclosure.

As previously discussed, channel 128 is configured to facilitate the flow of a coolant through power supply 104. In a non-limiting exemplary embodiment, channel 128 may facilitate the flow of coolant through each battery module of the plurality of battery modules to cool the battery pack via heat transfer.

In one or more non-limiting embodiments, the height of channel 128 may be less than the height of each battery cell of the plurality of battery cells. Channel 128 may be configured to include any curvature of the first side and/or second side of thermal conduit. For example and without limitation the curvature of the first side and/or second side of channel 128 correlates at least a portion of a battery cell of the plurality of battery cells. As a further example and without limitation, in an embodiment, channel 128 may be configured to include ten curves of the first surface of thermal conduit, wherein each curve is configured to contain the at least a portion of each battery cell of the plurality of battery cells adjacent to the first surface of thermal conduit. As a further example and without limitation, in some embodiments, channel 128 may be configured to include ten curves on the second surface of channel 128 wherein each curve may be configured to contain the at least a portion of each battery cell of the plurality of battery cells adjacent to the second surface of thermal conduit. The embodiment of channel 128 illustrates ten curves on each surface of thermal conduit, however this is non-limiting and channel 128 may include any number of curves on each surface of thermal conduit, wherein each curve corresponds to the at least a portion of a battery cell of the plurality of battery cells.

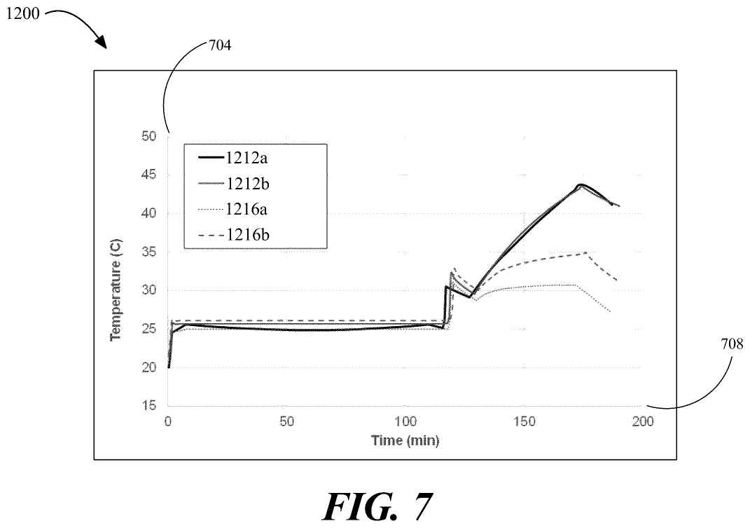

Referring now to FIG. 7, a graph 700 is depicted that illustrates an exemplary aircraft energy source temperature during a charging processes. Graph 700 illustrates an energy source temperature along a vertical axis 704, in degrees Celsius. Graph 700 illustrates time along a horizontal axis 708, in minutes. Graph 700 illustrates energy source temperature during recharge for the energy source in four different tests. During all four rechargings ambient air temperature was approximately 20° C. and recharging was performed for about 1 hour (from time equals approximately 120 min to time equals approximately 180 min). Prior to recharging in each case, aircraft energy source was used to take-off, fly approximately 200 nm, land, and cool (from time equals zero to time equals approximately 120 min). Recharge during each case was brought aircraft energy source from approximately a 25% state of charge to approximately a 98% state of charge. A first and second baseline recharge 712a-b are illustrated on graph in by way of solid lines. It can be seen from graph 700, that first baseline 712a and second baseline 712b overlap very closely with one another. Both first and second baseline 712a-b were performed without cooling. Graph 700 illustrates two recharging conditions that included active cooling 716a-b by way of dashed lines. During active cooling, for the tests depicted in graph 700, coolant was air having a temperature approximately equal to that of ambient. First active cooling 716a, indicated on graph 700 by way of smaller dashed line, was performed with coolant flow of approximately 1 standard cubic foot per minute (SCFM). Second active cooling 716b, indicated on graph 700 by way of larger dashed line, was performed with coolant flow of approximately 0.5 standard cubic feet per minute (SCFM).

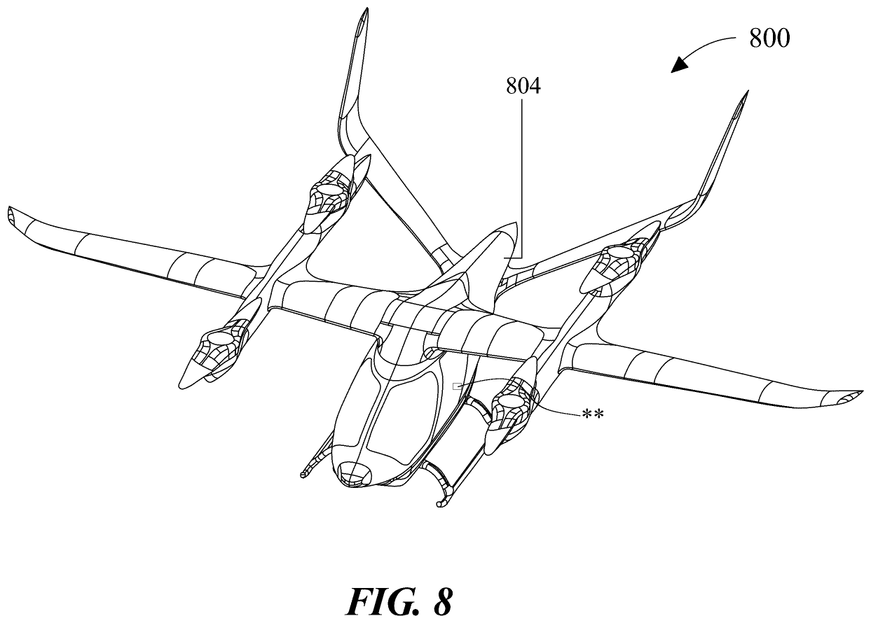

Referring now to FIG. 8, electric aircraft 800 may include a vertical takeoff and landing aircraft (eVTOL). As used herein, a vertical take-off and landing (eVTOL) aircraft is one that can hover, take off, and land vertically. An eVTOL, as used herein, is an electrically powered aircraft typically using an energy source, of a plurality of energy sources to power the aircraft. In order to optimize the power and energy necessary to propel the aircraft. eVTOL may be capable of rotor-based cruising flight, rotor-based takeoff, rotor-based landing, fixed-wing cruising flight, airplane-style takeoff, airplane-style landing, and/or any combination thereof. Rotor-based flight, as described herein, is where the aircraft generated lift and propulsion by way of one or more powered rotors coupled with an engine, such as a “quad copter,” multi-rotor helicopter, or other aircraft that maintains its lift primarily using downward thrusting propulsors. Fixed-wing flight, as described herein, is where the aircraft is capable of flight using wings and/or foils that generate life caused by the aircraft's forward airspeed and the shape of the wings and/or foils, such as airplane-style flight.

Still referring to FIG. 8, aircraft 800 may include a fuselage 804. As used in this disclosure a “fuselage” is the main body of an aircraft, or in other words, the entirety of the aircraft except for the cockpit, nose, wings, empennage, nacelles, any and all control surfaces, and generally contains an aircraft's payload. Fuselage 804 may comprise structural elements that physically support the shape and structure of an aircraft. Structural elements may take a plurality of forms, alone or in combination with other types. Structural elements may vary depending on the construction type of aircraft and specifically, the fuselage. Fuselage 804 may comprise a truss structure. A truss structure may be used with a lightweight aircraft and may include welded aluminum tube trusses. A truss, as used herein, is an assembly of beams that create a rigid structure, often in combinations of triangles to create three-dimensional shapes. A truss structure may alternatively comprise titanium construction in place of aluminum tubes, or a combination thereof. In some embodiments, structural elements may comprise aluminum tubes and/or titanium beams. In an embodiment, and without limitation, structural elements may include an aircraft skin. Aircraft skin may be layered over the body shape constructed by trusses. Aircraft skin may comprise a plurality of materials such as aluminum, fiberglass, and/or carbon fiber, the latter of which will be addressed in greater detail later in this paper. In one or more embodiments, electric aircraft 800 includes port 116. In one or more embodiments port 116 may be disposed within fuselage.

Still referring to FIG. 8, port 116 may be electrically connected to an energy source of electric aircraft 800. An energy source may include, for example, a generator, a photovoltaic device, a fuel cell such as a hydrogen fuel cell, direct methanol fuel cell, and/or solid oxide fuel cell, an electric energy storage device (e.g., a capacitor, an inductor, and/or a battery). An energy source may also include a battery cell, or a plurality of battery cells connected in series into a module and each module connected in series or in parallel with other modules. Configuration of an energy source containing connected modules may be designed to meet an energy or power requirement and may be designed to fit within a designated footprint in an electric aircraft in which system may be incorporated.

Still referring to FIG. 8, aircraft 800 may include a sensor. Sensor may include any sensor or noise monitoring circuit. Sensor may be configured to sense a characteristic of charging connection or condition and/or parameter of a power source of electric aircraft 800. Sensor may be a device, module, and/or subsystem, utilizing any hardware, software, and/or any combination thereof to sense a characteristic and/or changes thereof, in an instant environment, for instance without limitation controller, which the sensor is proximal to or otherwise in a sensed communication with, and transmit information associated with the characteristic, for instance without limitation digitized data. Sensor may be mechanically and/or communicatively connected to aircraft 800. In other embodiments, sensor may be communicatively connected to charger 124. Sensor may be configured to sense a characteristic associated with a power source of electric aircraft, such as a critical condition (e.g., overheating, overcurrent, gas detection, cell failure byproduct detection, moisture detection, and the like) and may transmit a control signal to controller 140 to terminate charging connection. Sensor may include one or more proximity sensors, position sensor, displacement sensors, vibration sensors, photoelectric sensors, infrared sensors, pressure sensor, electrical sensors, such as voltmeters and current sensors, moisture, sensors, chemical sensors, gas sensors, and the like. Sensor may be used to monitor the status of aircraft 500 for both critical and non-critical functions. Sensor may be incorporated into aircraft or aircraft or be remote.

In some cases, sensor 148 may sense a characteristic as an analog measurement, for instance, yielding a continuously variable electrical potential indicative of the sensed characteristic. In these cases, sensor 516 may additionally comprise an analog to digital converter (ADC) as well as any additionally circuitry, such as without limitation a Whetstone bridge, an amplifier, a filter, and the like. In one or more embodiments, sensor 148 may sense a characteristic through a digital means or digitize a sensed signal natively.

Still referring to FIG. 8, electric aircraft 800 may include a vertical takeoff and landing aircraft (eVTOL). As used herein, a vertical take-off and landing (eVTOL) aircraft is one that can hover, take off, and land vertically. An eVTOL, as used herein, is an electrically powered aircraft typically using an energy source, of a plurality of energy sources to power the aircraft. In order to optimize the power and energy necessary to propel the aircraft. eVTOL may be capable of rotor-based cruising flight, rotor-based takeoff, rotor-based landing, fixed-wing cruising flight, airplane-style takeoff, airplane-style landing, and/or any combination thereof. Rotor-based flight, as described herein, is where the aircraft generated lift and propulsion by way of one or more powered rotors coupled with an engine, such as a “quad copter,” multi-rotor helicopter, or other aircraft that maintains its lift primarily using downward thrusting propulsors. Fixed-wing flight, as described herein, is where the aircraft is capable of flight using wings and/or foils that generate life caused by the aircraft's forward airspeed and the shape of the wings and/or foils, such as airplane-style flight.

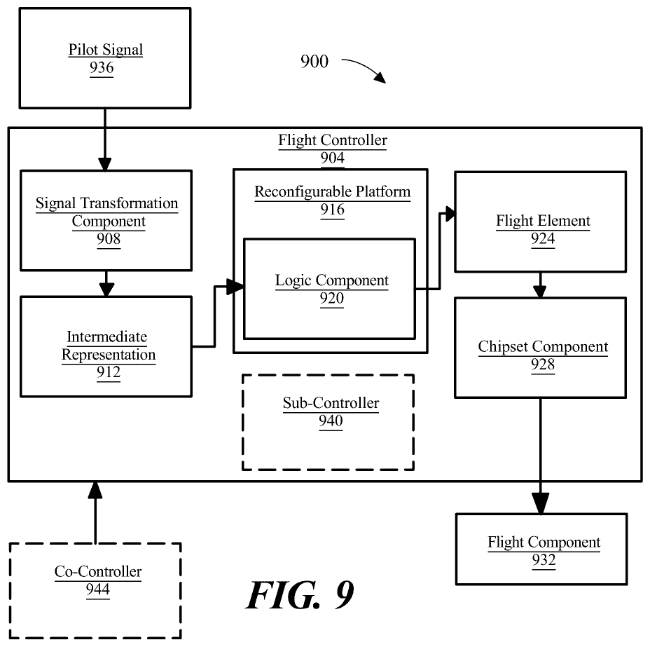

Now referring to FIG. 9, an exemplary embodiment 900 of a flight controller 904 is illustrated. As used in this disclosure a “flight controller” is a computing device of a plurality of computing devices dedicated to data storage, security, distribution of traffic for load balancing, and flight instruction. Flight controller 904 may include and/or communicate with any computing device as described in this disclosure, including without limitation a microcontroller, microprocessor, digital signal processor (DSP) and/or system on a chip (SoC) as described in this disclosure. Further, flight controller 904 may include a single computing device operating independently, or may include two or more computing device operating in concert, in parallel, sequentially or the like; two or more computing devices may be included together in a single computing device or in two or more computing devices. In embodiments, flight controller 904 may be installed in an aircraft, may control the aircraft remotely, and/or may include an element installed in the aircraft and a remote element in communication therewith.

In an embodiment, and still referring to FIG. 9, flight controller 904 may include a signal transformation component 908. As used in this disclosure a “signal transformation component” is a component that transforms and/or converts a first signal to a second signal, wherein a signal may include one or more digital and/or analog signals. For example, and without limitation, signal transformation component 908 may be configured to perform one or more operations such as preprocessing, lexical analysis, parsing, semantic analysis, and the like thereof. In an embodiment, and without limitation, signal transformation component 908 may include one or more analog-to-digital convertors that transform a first signal of an analog signal to a second signal of a digital signal. For example, and without limitation, an analog-to-digital converter may convert an analog input signal to a 10-bit binary digital representation of that signal. In another embodiment, signal transformation component 908 may include transforming one or more low-level languages such as, but not limited to, machine languages and/or assembly languages. For example, and without limitation, signal transformation component 908 may include transforming a binary language signal to an assembly language signal. In an embodiment, and without limitation, signal transformation component 908 may include transforming one or more high-level languages and/or formal languages such as but not limited to alphabets, strings, and/or languages. For example, and without limitation, high-level languages may include one or more system languages, scripting languages, domain-specific languages, visual languages, esoteric languages, and the like thereof. As a further non-limiting example, high-level languages may include one or more algebraic formula languages, business data languages, string and list languages, object-oriented languages, and the like thereof.

Still referring to FIG. 9, signal transformation component 908 may be configured to optimize an intermediate representation 912. As used in this disclosure an “intermediate representation” is a data structure and/or code that represents the input signal. Signal transformation component 908 may optimize intermediate representation as a function of a data-flow analysis, dependence analysis, alias analysis, pointer analysis, escape analysis, and the like thereof. In an embodiment, and without limitation, signal transformation component 908 may optimize intermediate representation 912 as a function of one or more inline expansions, dead code eliminations, constant propagation, loop transformations, and/or automatic parallelization functions. In another embodiment, signal transformation component 908 may optimize intermediate representation as a function of a machine dependent optimization such as a peephole optimization, wherein a peephole optimization may rewrite short sequences of code into more efficient sequences of code. Signal transformation component 908 may optimize intermediate representation to generate an output language, wherein an “output language,” as used herein, is the native machine language of flight controller 904. For example, and without limitation, native machine language may include one or more binary and/or numerical languages.

In an embodiment, and without limitation, signal transformation component 908 may include transform one or more inputs and outputs as a function of an error correction code. An error correction code, also known as error correcting code (ECC), is an encoding of a message or lot of data using redundant information, permitting recovery of corrupted data. An ECC may include a block code, in which information is encoded on fixed-size packets and/or blocks of data elements such as symbols of predetermined size, bits, or the like. Reed-Solomon coding, in which message symbols within a symbol set having q symbols are encoded as coefficients of a polynomial of degree less than or equal to a natural number k, over a finite field F with q elements; strings so encoded have a minimum hamming distance of k+1, and permit correction of (q−k−1)/2 erroneous symbols. Block code may alternatively or additionally be implemented using Golay coding, also known as binary Golay coding, Bose-Chaudhuri, Hocquenghuem (BCH) coding, multidimensional parity-check coding, and/or Hamming codes. An ECC may alternatively or additionally be based on a convolutional code.

In an embodiment, and still referring to FIG. 9, flight controller 904 may include a reconfigurable hardware platform 916. A “reconfigurable hardware platform,” as used herein, is a component and/or unit of hardware that may be reprogrammed, such that, for instance, a data path between elements such as logic gates or other digital circuit elements may be modified to change an algorithm, state, logical sequence, or the like of the component and/or unit. This may be accomplished with such flexible high-speed computing fabrics as field-programmable gate arrays (FPGAs), which may include a grid of interconnected logic gates, connections between which may be severed and/or restored to program in modified logic. Reconfigurable hardware platform 916 may be reconfigured to enact any algorithm and/or algorithm selection process received from another computing device and/or created using machine-learning processes.

Still referring to FIG. 9, reconfigurable hardware platform 916 may include a logic component 920. As used in this disclosure a “logic component” is a component that executes instructions on output language. For example, and without limitation, logic component may perform basic arithmetic, logic, controlling, input/output operations, and the like thereof. Logic component 920 may include any suitable processor, such as without limitation a component incorporating logical circuitry for performing arithmetic and logical operations, such as an arithmetic and logic unit (ALU), which may be regulated with a state machine and directed by operational inputs from memory and/or sensors; logic component 920 may be organized according to Von Neumann and/or Harvard architecture as a non-limiting example. Logic component 920 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating-point unit (FPU), and/or system on a chip (SoC). In an embodiment, logic component 920 may include one or more integrated circuit microprocessors, which may contain one or more central processing units, central processors, and/or main processors, on a single metal-oxide-semiconductor chip. Logic component 920 may be configured to execute a sequence of stored instructions to be performed on the output language and/or intermediate representation 912. Logic component 920 may be configured to fetch and/or retrieve the instruction from a memory cache, wherein a “memory cache,” as used in this disclosure, is a stored instruction set on flight controller 904. Logic component 920 may be configured to decode the instruction retrieved from the memory cache to opcodes and/or operands. Logic component 920 may be configured to execute the instruction on intermediate representation 912 and/or output language. For example, and without limitation, logic component 920 may be configured to execute an addition operation on intermediate representation 912 and/or output language.

In an embodiment, and without limitation, logic component 920 may be configured to calculate a flight element 924. As used in this disclosure a “flight element” is an element of datum denoting a relative status of aircraft. For example, and without limitation, flight element 924 may denote one or more torques, thrusts, airspeed velocities, forces, altitudes, groundspeed velocities, directions during flight, directions facing, forces, orientations, and the like thereof. For example, and without limitation, flight element 924 may denote that aircraft is cruising at an altitude and/or with a sufficient magnitude of forward thrust. As a further non-limiting example, flight status may denote that is building thrust and/or groundspeed velocity in preparation for a takeoff. As a further non-limiting example, flight element 924 may denote that aircraft is following a flight path accurately and/or sufficiently.

Still referring to FIG. 9, flight controller 904 may include a chipset component 928. As used in this disclosure a “chipset component” is a component that manages data flow. In an embodiment, and without limitation, chipset component 928 may include a northbridge data flow path, wherein the northbridge dataflow path may manage data flow from logic component 920 to a high-speed device and/or component, such as a RAM, graphics controller, and the like thereof. In another embodiment, and without limitation, chipset component 928 may include a southbridge data flow path, wherein the southbridge dataflow path may manage data flow from logic component 920 to lower-speed peripheral buses, such as a peripheral component interconnect (PCI), industry standard architecture (ICA), and the like thereof. In an embodiment, and without limitation, southbridge data flow path may include managing data flow between peripheral connections such as ethernet, USB, audio devices, and the like thereof. Additionally or alternatively, chipset component 928 may manage data flow between logic component 920, memory cache, and a flight component 932. As used in this disclosure a “flight component” is a portion of an aircraft that can be moved or adjusted to affect one or more flight elements. For example, flight component 1432 may include a component used to affect the aircrafts' roll and pitch which may comprise one or more ailerons. As a further example, flight component 932 may include a rudder to control yaw of an aircraft. In an embodiment, chipset component 928 may be configured to communicate with a plurality of flight components as a function of flight element 924. For example, and without limitation, chipset component 928 may transmit to an aircraft rotor to reduce torque of a first lift propulsor and increase the forward thrust produced by a pusher component to perform a flight maneuver.

In an embodiment, and still referring to FIG. 9, flight controller 904 may be configured generate an autonomous function. As used in this disclosure an “autonomous function” is a mode and/or function of flight controller 904 that controls aircraft automatically. For example, and without limitation, autonomous function may perform one or more aircraft maneuvers, take offs, landings, altitude adjustments, flight leveling adjustments, turns, climbs, and/or descents. As a further non-limiting example, autonomous function may adjust one or more airspeed velocities, thrusts, torques, and/or groundspeed velocities. As a further non-limiting example, autonomous function may perform one or more flight path corrections and/or flight path modifications as a function of flight element 924. In an embodiment, autonomous function may include one or more modes of autonomy such as, but not limited to, autonomous mode, semi-autonomous mode, and/or non-autonomous mode. As used in this disclosure “autonomous mode” is a mode that automatically adjusts and/or controls aircraft and/or the maneuvers of aircraft in its entirety. For example, autonomous mode may denote that flight controller 904 will adjust the aircraft. As used in this disclosure a “semi-autonomous mode” is a mode that automatically adjusts and/or controls a portion and/or section of aircraft. For example, and without limitation, semi-autonomous mode may denote that a pilot will control the propulsors, wherein flight controller 904 will control the ailerons and/or rudders. As used in this disclosure “non-autonomous mode” is a mode that denotes a pilot will control aircraft and/or maneuvers of aircraft in its entirety.

In an embodiment, and still referring to FIG. 9, flight controller 904 may generate autonomous function as a function of an autonomous machine-learning model. As used in this disclosure an “autonomous machine-learning model” is a machine-learning model to produce an autonomous function output given flight element 924 and a pilot signal 936 as inputs; this is in contrast to a non-machine learning software program where the commands to be executed are determined in advance by a user and written in a programming language. As used in this disclosure a “pilot signal” is an element of datum representing one or more functions a pilot is controlling and/or adjusting. For example, pilot signal 936 may denote that a pilot is controlling and/or maneuvering ailerons, wherein the pilot is not in control of the rudders and/or propulsors. In an embodiment, pilot signal 936 may include an implicit signal and/or an explicit signal. For example, and without limitation, pilot signal 936 may include an explicit signal, wherein the pilot explicitly states there is a lack of control and/or desire for autonomous function. As a further non-limiting example, pilot signal 936 may include an explicit signal directing flight controller 904 to control and/or maintain a portion of aircraft, a portion of the flight plan, the entire aircraft, and/or the entire flight plan. As a further non-limiting example, pilot signal 936 may include an implicit signal, wherein flight controller 904 detects a lack of control such as by a malfunction, torque alteration, flight path deviation, and the like thereof. In an embodiment, and without limitation, pilot signal 936 may include one or more explicit signals to reduce torque, and/or one or more implicit signals that torque may be reduced due to reduction of airspeed velocity. In an embodiment, and without limitation, pilot signal 936 may include one or more local and/or global signals. For example, and without limitation, pilot signal 936 may include a local signal that is transmitted by a pilot and/or crew member. As a further non-limiting example, pilot signal 936 may include a global signal that is transmitted by air traffic control and/or one or more remote users that are in communication with the pilot of aircraft. In an embodiment, pilot signal 936 may be received as a function of a tri-state bus and/or multiplexor that denotes an explicit pilot signal should be transmitted prior to any implicit or global pilot signal.

Still referring to FIG. 9, autonomous machine-learning model may include one or more autonomous machine-learning processes such as supervised, unsupervised, or reinforcement machine-learning processes that flight controller 904 and/or a remote device may or may not use in the generation of autonomous function. As used in this disclosure “remote device” is an external device to flight controller 904. Additionally or alternatively, autonomous machine-learning model may include one or more autonomous machine-learning processes that a field-programmable gate array (FPGA) may or may not use in the generation of autonomous function. Autonomous machine-learning process may include, without limitation machine learning processes such as simple linear regression, multiple linear regression, polynomial regression, support vector regression, ridge regression, lasso regression, elasticnet regression, decision tree regression, random forest regression, logistic regression, logistic classification, K-nearest neighbors, support vector machines, kernel support vector machines, naïve bayes, decision tree classification, random forest classification, K-means clustering, hierarchical clustering, dimensionality reduction, principal component analysis, linear discriminant analysis, kernel principal component analysis, Q-learning, State Action Reward State Action (SARSA), Deep-Q network, Markov decision processes, Deep Deterministic Policy Gradient (DDPG), or the like thereof.

In an embodiment, and still referring to FIG. 9, autonomous machine learning model may be trained as a function of autonomous training data, wherein autonomous training data may correlate a flight element, pilot signal, and/or simulation data to an autonomous function. For example, and without limitation, a flight element of an airspeed velocity, a pilot signal of limited and/or no control of propulsors, and a simulation data of required airspeed velocity to reach the destination may result in an autonomous function that includes a semi-autonomous mode to increase thrust of the propulsors. Autonomous training data may be received as a function of user-entered valuations of flight elements, pilot signals, simulation data, and/or autonomous functions. Flight controller 904 may receive autonomous training data by receiving correlations of flight element, pilot signal, and/or simulation data to an autonomous function that were previously received and/or determined during a previous iteration of generation of autonomous function. Autonomous training data may be received by one or more remote devices and/or FPGAs that at least correlate a flight element, pilot signal, and/or simulation data to an autonomous function. Autonomous training data may be received in the form of one or more user-entered correlations of a flight element, pilot signal, and/or simulation data to an autonomous function.

Still referring to FIG. 9, flight controller 904 may receive autonomous machine-learning model from a remote device and/or FPGA that utilizes one or more autonomous machine learning processes, wherein a remote device and an FPGA is described above in detail. For example, and without limitation, a remote device may include a computing device, external device, processor, FPGA, microprocessor and the like thereof. Remote device and/or FPGA may perform the autonomous machine-learning process using autonomous training data to generate autonomous function and transmit the output to flight controller 904. Remote device and/or FPGA may transmit a signal, bit, datum, or parameter to flight controller 904 that at least relates to autonomous function. Additionally or alternatively, the remote device and/or FPGA may provide an updated machine-learning model. For example, and without limitation, an updated machine-learning model may be comprised of a firmware update, a software update, an autonomous machine-learning process correction, and the like thereof. As a non-limiting example a software update may incorporate a new simulation data that relates to a modified flight element. Additionally or alternatively, the updated machine learning model may be transmitted to the remote device and/or FPGA, wherein the remote device and/or FPGA may replace the autonomous machine-learning model with the updated machine-learning model and generate the autonomous function as a function of the flight element, pilot signal, and/or simulation data using the updated machine-learning model. The updated machine-learning model may be transmitted by the remote device and/or FPGA and received by flight controller 904 as a software update, firmware update, or corrected autonomous machine-learning model. For example, and without limitation autonomous machine learning model may utilize a neural net machine-learning process, wherein the updated machine-learning model may incorporate a gradient boosting machine-learning process.

Still referring to FIG. 9, flight controller 904 may include, be included in, and/or communicate with a mobile device such as a mobile telephone or smartphone. Further, flight controller may communicate with one or more additional devices as described below in further detail via a network interface device. The network interface device may be utilized for commutatively connecting a flight controller to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. The network may include any network topology and can may employ a wired and/or a wireless mode of communication.

In an embodiment, and still referring to FIG. 9, flight controller 904 may include, but is not limited to, for example, a cluster of flight controllers in a first location and a second flight controller or cluster of flight controllers in a second location. Flight controller 904 may include one or more flight controllers dedicated to data storage, security, distribution of traffic for load balancing, and the like. Flight controller 904 may be configured to distribute one or more computing tasks as described below across a plurality of flight controllers, which may operate in parallel, in series, redundantly, or in any other manner used for distribution of tasks or memory between computing devices. For example, and without limitation, flight controller 904 may implement a control algorithm to distribute and/or command the plurality of flight controllers. As used in this disclosure a “control algorithm” is a finite sequence of well-defined computer implementable instructions that may determine the flight component of the plurality of flight components to be adjusted. For example, and without limitation, control algorithm may include one or more algorithms that reduce and/or prevent aviation asymmetry. As a further non-limiting example, control algorithms may include one or more models generated as a function of a software including, but not limited to Simulink by MathWorks, Natick, Massachusetts, USA. In an embodiment, and without limitation, control algorithm may be configured to generate an auto-code, wherein an “auto-code,” is used herein, is a code and/or algorithm that is generated as a function of the one or more models and/or software's. In another embodiment, control algorithm may be configured to produce a segmented control algorithm. As used in this disclosure a “segmented control algorithm” is control algorithm that has been separated and/or parsed into discrete sections. For example, and without limitation, segmented control algorithm may parse control algorithm into two or more segments, wherein each segment of control algorithm may be performed by one or more flight controllers operating on distinct flight components.

In an embodiment, and still referring to FIG. 9, control algorithm may be configured to determine a segmentation boundary as a function of segmented control algorithm. As used in this disclosure a “segmentation boundary” is a limit and/or delineation associated with the segments of the segmented control algorithm. For example, and without limitation, segmentation boundary may denote that a segment in the control algorithm has a first starting section and/or a first ending section. As a further non-limiting example, segmentation boundary may include one or more boundaries associated with an ability of flight component 932. In an embodiment, control algorithm may be configured to create an optimized signal communication as a function of segmentation boundary. For example, and without limitation, optimized signal communication may include identifying the discrete timing required to transmit and/or receive the one or more segmentation boundaries. In an embodiment, and without limitation, creating optimized signal communication further comprises separating a plurality of signal codes across the plurality of flight controllers. For example, and without limitation the plurality of flight controllers may include one or more formal networks, wherein formal networks transmit data along an authority chain and/or are limited to task-related communications. As a further non-limiting example, communication network may include informal networks, wherein informal networks transmit data in any direction. In an embodiment, and without limitation, the plurality of flight controllers may include a chain path, wherein a “chain path,” as used herein, is a linear communication path comprising a hierarchy that data may flow through. In an embodiment, and without limitation, the plurality of flight controllers may include an all-channel path, wherein an “all-channel path,” as used herein, is a communication path that is not restricted to a particular direction. For example, and without limitation, data may be transmitted upward, downward, laterally, and the like thereof. In an embodiment, and without limitation, the plurality of flight controllers may include one or more neural networks that assign a weighted value to a transmitted datum. For example, and without limitation, a weighted value may be assigned as a function of one or more signals denoting that a flight component is malfunctioning and/or in a failure state.

Still referring to FIG. 9, the plurality of flight controllers may include a master bus controller. As used in this disclosure a “master bus controller” is one or more devices and/or components that are connected to a bus to initiate a direct memory access transaction, wherein a bus is one or more terminals in a bus architecture. Master bus controller may communicate using synchronous and/or asynchronous bus control protocols. In an embodiment, master bus controller may include flight controller 904. In another embodiment, master bus controller may include one or more universal asynchronous receiver-transmitters (UART). For example, and without limitation, master bus controller may include one or more bus architectures that allow a bus to initiate a direct memory access transaction from one or more buses in the bus architectures. As a further non-limiting example, master bus controller may include one or more peripheral devices and/or components to communicate with another peripheral device and/or component and/or the master bus controller. In an embodiment, master bus controller may be configured to perform bus arbitration. As used in this disclosure “bus arbitration” is method and/or scheme to prevent multiple buses from attempting to communicate with and/or connect to master bus controller. For example and without limitation, bus arbitration may include one or more schemes such as a small computer interface system, wherein a small computer interface system is a set of standards for physical connecting and transferring data between peripheral devices and master bus controller by defining commands, protocols, electrical, optical, and/or logical interfaces. In an embodiment, master bus controller may receive intermediate representation 912 and/or output language from logic component 920, wherein output language may include one or more analog-to-digital conversions, low bit rate transmissions, message encryptions, digital signals, binary signals, logic signals, analog signals, and the like thereof described above in detail.

Still referring to FIG. 9, master bus controller may communicate with a slave bus. As used in this disclosure a “slave bus” is one or more peripheral devices and/or components that initiate a bus transfer. For example, and without limitation, slave bus may receive one or more controls and/or asymmetric communications from master bus controller, wherein slave bus transfers data stored to master bus controller. In an embodiment, and without limitation, slave bus may include one or more internal buses, such as but not limited to a/an internal data bus, memory bus, system bus, front-side bus, and the like thereof. In another embodiment, and without limitation, slave bus may include one or more external buses such as external flight controllers, external computers, remote devices, printers, aircraft computer systems, flight control systems, and the like thereof.

In an embodiment, and still referring to FIG. 9, control algorithm may optimize signal communication as a function of determining one or more discrete timings. For example, and without limitation master bus controller may synchronize timing of the segmented control algorithm by injecting high priority timing signals on a bus of the master bus control. As used in this disclosure a “high priority timing signal” is information denoting that the information is important. For example, and without limitation, high priority timing signal may denote that a section of control algorithm is of high priority and should be analyzed and/or transmitted prior to any other sections being analyzed and/or transmitted. In an embodiment, high priority timing signal may include one or more priority packets. As used in this disclosure a “priority packet” is a formatted unit of data that is communicated between the plurality of flight controllers. For example, and without limitation, priority packet may denote that a section of control algorithm should be used and/or is of greater priority than other sections.

Still referring to FIG. 9, flight controller 904 may also be implemented using a “shared nothing” architecture in which data is cached at the worker, in an embodiment, this may enable scalability of aircraft and/or computing device. Flight controller 904 may include a distributer flight controller. As used in this disclosure a “distributer flight controller” is a component that adjusts and/or controls a plurality of flight components as a function of a plurality of flight controllers. For example, distributer flight controller may include a flight controller that communicates with a plurality of additional flight controllers and/or clusters of flight controllers. In an embodiment, distributed flight control may include one or more neural networks. For example, neural network also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes, one or more intermediate layers, and an output layer of nodes. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 9, a node may include, without limitation a plurality of inputs xi that may receive numerical values from inputs to a neural network containing the node and/or from other nodes. Node may perform a weighted sum of inputs using weights wi that are multiplied by respective inputs xi. Additionally or alternatively, a bias b may be added to the weighted sum of the inputs such that an offset is added to each unit in the neural network layer that is independent of the input to the layer. The weighted sum may then be input into a function co, which may generate one or more outputs y. Weight wi applied to an input xi may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wi may be determined by training a neural network using training data, which may be performed using any suitable process as described above. In an embodiment, and without limitation, a neural network may receive semantic units as inputs and output vectors representing such semantic units according to weights wi that are derived using machine-learning processes as described in this disclosure.

Still referring to FIG. 9, flight controller may include a sub-controller 940. As used in this disclosure a “sub-controller” is a controller and/or component that is part of a distributed controller as described above; for instance, flight controller 904 may be and/or include a distributed flight controller made up of one or more sub-controllers. For example, and without limitation, sub-controller 940 may include any controllers and/or components thereof that are similar to distributed flight controller and/or flight controller as described above. Sub-controller 940 may include any component of any flight controller as described above. Sub-controller 940 may be implemented in any manner suitable for implementation of a flight controller as described above. As a further non-limiting example, sub-controller 940 may include one or more processors, logic components and/or computing devices capable of receiving, processing, and/or transmitting data across the distributed flight controller as described above. As a further non-limiting example, sub-controller 940 may include a controller that receives a signal from a first flight controller and/or first distributed flight controller component and transmits the signal to a plurality of additional sub-controllers and/or flight components.

Still referring to FIG. 9, flight controller may include a co-controller 944. As used in this disclosure a “co-controller” is a controller and/or component that joins flight controller 904 as components and/or nodes of a distributer flight controller as described above. For example, and without limitation, co-controller 944 may include one or more controllers and/or components that are similar to flight controller 904. As a further non-limiting example, co-controller 944 may include any controller and/or component that joins flight controller 904 to distributer flight controller. As a further non-limiting example, co-controller 944 may include one or more processors, logic components and/or computing devices capable of receiving, processing, and/or transmitting data to and/or from flight controller 904 to distributed flight control system. Co-controller 944 may include any component of any flight controller as described above. Co-controller 944 may be implemented in any manner suitable for implementation of a flight controller as described above.

In an embodiment, and with continued reference to FIG. 9, flight controller 904 may be designed and/or configured to perform any method, method step, or sequence of method steps in any embodiment described in this disclosure, in any order and with any degree of repetition. For instance, flight controller 904 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Flight controller may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

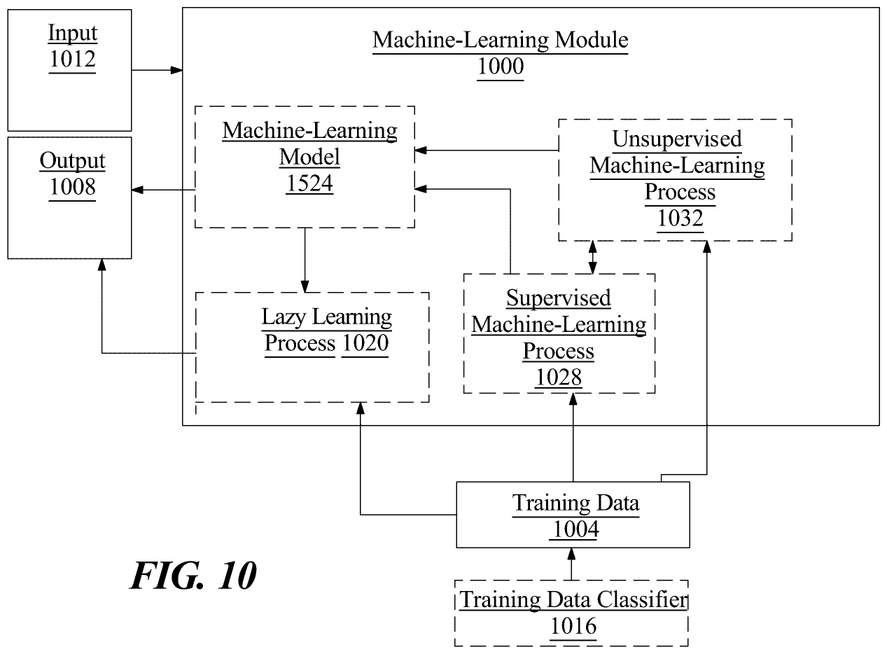

Referring now to FIG. 10, an exemplary embodiment of a machine-learning module 1000 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 1004 to generate an algorithm that will be performed by a computing device/module to produce outputs 1008 given data provided as inputs 1012; this is in contrast to a non-machine learning software program where the commands to be executed are determined in advance by a user and written in a programming language.

Still referring to FIG. 10, “training data,” as used herein, is data containing correlations that a machine-learning process may use to model relationships between two or more categories of data elements. For instance, and without limitation, training data 1004 may include a plurality of data entries, each entry representing a set of data elements that were recorded, received, and/or generated together; data elements may be correlated by shared existence in a given data entry, by proximity in a given data entry, or the like. Multiple data entries in training data 1004 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 1004 according to various correlations; correlations may indicate causative and/or predictive links between categories of data elements, which may be modeled as relationships such as mathematical relationships by machine-learning processes as described in further detail below. Training data 1004 may be formatted and/or organized by categories of data elements, for instance by associating data elements with one or more descriptors corresponding to categories of data elements. As a non-limiting example, training data 1004 may include data entered in standardized forms by persons or processes, such that entry of a given data element in a given field in a form may be mapped to one or more descriptors of categories. Elements in training data 1004 may be linked to descriptors of categories by tags, tokens, or other data elements; for instance, and without limitation, training data 1004 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 10, training data 1004 may include one or more elements that are not categorized; that is, training data 1004 may not be formatted or contain descriptors for some elements of data. Machine-learning algorithms and/or other processes may sort training data 1004 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 1004 to be made applicable for two or more distinct machine-learning algorithms as described in further detail below. Training data 1004 used by machine-learning module 1000 may correlate any input data as described in this disclosure to any output data as described in this disclosure. As a non-limiting illustrative example flight elements and/or pilot signals may be inputs, wherein an output may be an autonomous function.

Further referring to FIG. 10, training data may be filtered, sorted, and/or selected using one or more supervised and/or unsupervised machine-learning processes and/or models as described in further detail below; such models may include without limitation a training data classifier 1016. Training data classifier 1016 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 1000 may generate a classifier using a classification algorithm, defined as a processes whereby a computing device and/or any module and/or component operating thereon derives a classifier from training data 1004. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 1616 may classify elements of training data to sub-categories of flight elements such as torques, forces, thrusts, directions, and the like thereof.

Still referring to FIG. 10, machine-learning module 1000 may be configured to perform a lazy-learning process 1020 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 1004. Heuristic may include selecting some number of highest-ranking associations and/or training data 1004 elements. Lazy learning may implement any suitable lazy learning algorithm, including without limitation a K-nearest neighbors algorithm, a lazy naive Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 10, machine-learning processes as described in this disclosure may be used to generate machine-learning models 1024. A “machine-learning model,” as used in this disclosure, is a mathematical and/or algorithmic representation of a relationship between inputs and outputs, as generated using any machine-learning process including without limitation any process as described above and stored in memory; an input is submitted to a machine-learning model 1024 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 1024 may be generated by creating an artificial neural network, such as a convolutional neural network comprising an input layer of nodes, one or more intermediate layers, and an output layer of nodes. Connections between nodes may be created via the process of “training” the network, in which elements from a training data 1004 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 10, machine-learning algorithms may include at least a supervised machine-learning process 1028. At least a supervised machine-learning process 1028, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include flight elements and/or pilot signals as described above as inputs, autonomous functions as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 1004. Persons skilled in the art, upon reviewing the entirety of this disclosure, will be aware of various possible variations of at least a supervised machine-learning process 1028 that may be used to determine relation between inputs and outputs. Supervised machine-learning processes may include classification algorithms as defined above.

Further referring to FIG. 10, machine learning processes may include at least an unsupervised machine-learning processes 1032. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 10, machine-learning module 1000 may be designed and configured to create a machine-learning model 1024 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 10, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

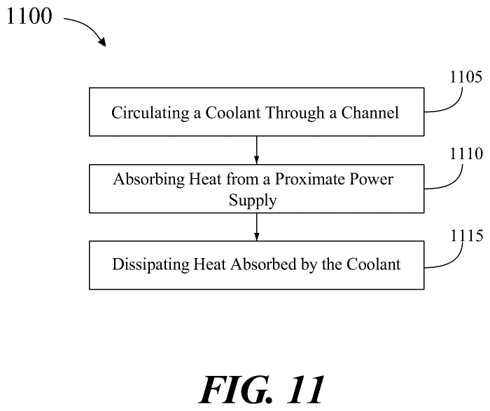

Referring now to FIG. 11, an exemplary method 1100 for cooling a power source assembly of an electric aircraft during charging. Step 1105 of method 110 includes circulating, by coolant source, coolant through channel. In one or more non-limiting embodiments, coolant may be glycol, water, and the like. Coolant may be operated by a controller, which turns coolant ON and OFF. For instance, and without limitation, method 1100 may generating, by controller communicatively connected to coolant source, a control signal that operates coolant source. Control signal may provide instructions for coolant source to turn ON or OFF, as previously mentioned, or control signal may alter a mode of operation of coolant source, such as increasing or decreasing the flow rate of coolant through channel. In one or more embodiments, method 300 may also include detecting, by sensor communicatively connected to controller, a characteristic of power supply; and transmitting, by sensor, a sensor signal related to the detected characteristic to controller so that controller generates a control signal as a function of the sensor signal. In one or more embodiments, sensor may include a proximity sensor, which is configured to generate a sensor signal that indicates when a connector of a charger is mated with port of electric aircraft.

As shown in step 1110, method 1100 includes absorbing, by coolant, heat from a proximate power supply. Channel may abut power supply or channel may traverse through components of power supply. For example, and without limitation, channel may be woven between battery cells or modules of a battery pack of power supply. In one or more embodiments, channel extends from energy source to electric port of power supply. For example, and without limitation, channel is arranged in a loop. In one or more embodiments, channel abuts power supply. In one or more embodiments, channel abuts energy source of power supply.

As shown in step 1115, method 300 includes dissipating, by heat exchanger, heat absorbed by a coolant. In one or more embodiments, heat exchanger may be a radiator. Once the heat has been dissipated from coolant, as thus a desired temperature of coolant has been achieved, coolant may be circulated by coolant source back to coolant source, such as to a reservoir of coolant source where method 300 may then be repeated any number of times necessary to maintain a desirable temperature of power supply.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

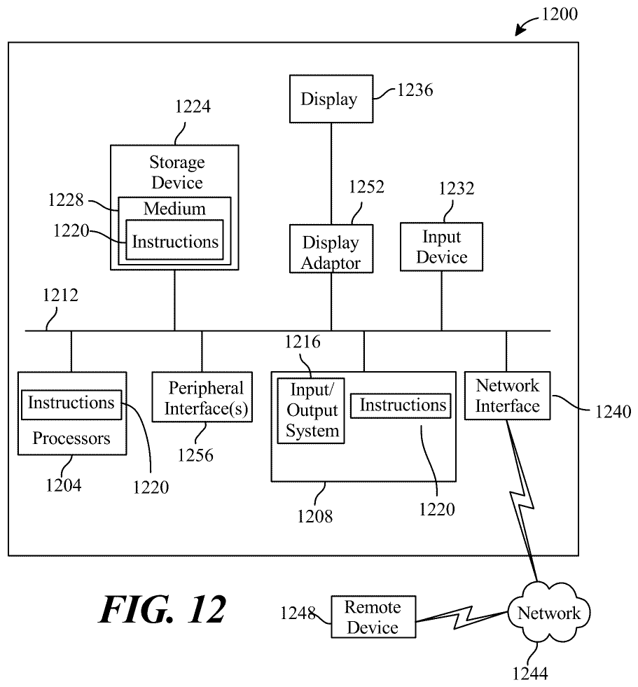

FIG. 12 shows a diagrammatic representation of one embodiment of a computing device in the exemplary form of a computer system 1200 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1200 includes a processor 1204 and a memory 1208 that communicate with each other, and with other components, via a bus 1212. Bus 1212 may include any of several types of bus structures including, but not limited to, a memory bus, a memory controller, a peripheral bus, a local bus, and any combinations thereof, using any of a variety of bus architectures.

Processor 1204 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1204 may be organized according to Von Neumann and/or Harvard architecture as a non-limiting example. Processor 1204 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating-point unit (FPU), and/or system on a chip (SoC).

Memory 1208 may include various components (e.g., machine-readable media) including, but not limited to, a random-access memory component, a read only component, and any combinations thereof. In one example, a basic input/output system 1216 (BIOS), including basic routines that help to transfer information between elements within computer system 1200, such as during start-up, may be stored in memory 1208. Memory 1208 may also include (e.g., stored on one or more machine-readable media) instructions (e.g., software) 1220 embodying any one or more of the aspects and/or methodologies of the present disclosure. In another example, memory 1208 may further include any number of program modules including, but not limited to, an operating system, one or more application programs, other program modules, program data, and any combinations thereof.

Computer system 1200 may also include a storage device 1224. Examples of a storage device (e.g., storage device 1224) include, but are not limited to, a hard disk drive, a magnetic disk drive, an optical disc drive in combination with an optical medium, a solid-state memory device, and any combinations thereof. Storage device 1224 may be connected to bus 1212 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1224 (or one or more components thereof) may be removably interfaced with computer system 1200 (e.g., via an external port connector (not shown)). Particularly, storage device 1224 and an associated machine-readable medium 1228 may provide nonvolatile and/or volatile storage of machine-readable instructions, data structures, program modules, and/or other data for computer system 1200. In one example, software 1220 may reside, completely or partially, within machine-readable medium 1228. In another example, software 1220 may reside, completely or partially, within processor 1204.

Computer system 1200 may also include an input device 1232. In one example, a user of computer system 1200 may enter commands and/or other information into computer system 1200 via input device 1232. Examples of an input device 1232 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1232 may be interfaced to bus 1212 via any of a variety of interfaces (not shown) including, but not limited to, a serial interface, a parallel interface, a game port, a USB interface, a FIREWIRE interface, a direct interface to bus 1212, and any combinations thereof. Input device 1232 may include a touch screen interface that may be a part of or separate from display 1236, discussed further below. Input device 1232 may be utilized as a user selection device for selecting one or more graphical representations in a graphical interface as described above.

A user may also input commands and/or other information to computer system 1200 via storage device 1224 (e.g., a removable disk drive, a flash drive, etc.) and/or network interface device 1240. A network interface device, such as network interface device 1240, may be utilized for connecting computer system 1200 to one or more of a variety of networks, such as network 1244, and one or more remote devices 1248 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1244, may employ a wired and/or a wireless mode of communication. In general, any network topology may be used. Information (e.g., data, software 1220, etc.) may be communicated to and/or from computer system 1200 via network interface device 1240.

Computer system 1200 may further include a video display adapter 1252 for communicating a displayable image to a display device, such as display device 1236. Examples of a display device include, but are not limited to, a liquid crystal display (LCD), a cathode ray tube (CRT), a plasma display, a light emitting diode (LED) display, and any combinations thereof. Display adapter 1252 and display device 1236 may be utilized in combination with processor 1204 to provide graphical representations of aspects of the present disclosure. In addition to a display device, computer system 1200 may include one or more other peripheral output devices including, but not limited to, an audio speaker, a printer, and any combinations thereof. Such peripheral output devices may be connected to bus 1212 via a peripheral interface 1256. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. A cooling system for a power supply of an electric aircraft, the system comprising:
a channel extending throughout the power supply of the electric aircraft, the channel configured to contain a coolant that absorbs heat from the power supply during charging of an energy source of the power supply, wherein a passage of the channel contacts a plurality of battery cells of the power supply;
a heat exchanger configured to dissipate the heat absorbed by the coolant;
a coolant source configured to circulate the coolant through the channel; and
a controller configured to control a temperature of the coolant as a function of a detected temperature of the coolant;
a pressure sensor configured to detect a force exerted by the coolant source to move the coolant through the channel, wherein the pressure sensor is configured to transmit a sensor signal indicative of the force to the controller.

2. The system of claim 1, wherein the channel extends from the energy source to an electric port of the power supply.

3. The system of claim 1, wherein the channel is arranged in a loop.

4. The system of claim 1, wherein the channel abuts the power supply.

5. The system of claim 4, wherein the channel abuts the energy source.

6. The system of claim 1, wherein the channel comprises a duct.

7. The system of claim 1, wherein the heat exchanger is a radiator.

8. The system of claim 1, wherein the coolant source comprises a pump.

9. The system of claim 1, wherein the controller is communicatively connected to the coolant source and configured generate a control signal that operates the coolant source.

10. The system of claim 9, further comprising a sensor configured to:
detect a characteristic of the power supply; and
transmit a sensor signal related to the detected characteristic to the controller so that the controller is configured to generate the control signal as a function of the sensor signal.

11. The system of claim 10, wherein the sensor comprises a proximity sensor configured to generate the sensor signal that indicates if a connector of a charger is mated with a port of the electric aircraft.

12. The system of claim 1, wherein the coolant comprises glycol.

13. A method for cooling a power supply of an electric aircraft during charging, the method comprising:
circulating, by a coolant source, a coolant through a channel wherein a passage of the channel contacts a plurality of battery cells of the power supply;
absorbing, by the coolant, heat from the power supply;
controlling, by a controller, a temperature of the coolant as a function of a detected temperature of the coolant
dissipating, by a heat exchanger, heat absorbed by the coolant; and
detecting, by a pressure sensor, a force exerted by the coolant source to move the coolant through the channel, wherein the pressure sensor is configured to transmit a sensor signal indicative of the force to a controller.

14. The method of claim 13, wherein the channel extends from an energy source to an electric port of the power supply.

15. The method of claim 13, wherein the channel abuts the power supply.

16. The method of claim 13, wherein the channel comprises a duct.

17. The method of claim 13, wherein the heat exchanger is a radiator.

18. The method of claim 13, wherein the coolant source comprises a pump.

19. The method of claim 13, wherein the controller is communicatively connected to the coolant source, and configured to generate a control signal that operates the coolant source.

20. The method of claim 19, further comprising:
detecting, by a sensor communicative connected to the controller, a characteristic of the power supply; and
transmitting, by the sensor, a sensor signal related to the detected characteristic to the controller so that the controller generates the control signal as a function of the sensor signal.
